(19) United States
(12) Patent Application Publication
(10) Pub. No.: US 2014/0164125 A1
(43) Pub. Date: Jun. 12, 2014

(54) System and Methods for Geographically-Driven Downstream Distribution of Mobile Content

(71) Applicant: Container Media, LLC, Mount Pleasant, SC (US)

(72) Inventor: Will Taylor, Mount Pleasant, SC (US)

(73) Assignee: Container Media, LLC, Mount Pleasant, SC (US)

(21) Appl. No.: 13/898,174

(22) Filed: May 20, 2013

Related U.S. Application Data
(60) Provisional application No. 61/648,903, filed on May 18, 2012.

(51) Int. Cl. G06Q 30/02

(52) U.S. Cl. CPC G06Q 30/0267; G06Q 30/0261
USPC 705/14.58

(57) ABSTRACT

Aspects of the present disclosure generally relate to a system and methods for distributing targeted content to users of mobile devices such as smartphones and other hand-held devices based on the user's geo-location and other user-specific parameters. Generally, the distribution of content may be regulated by numerous indicators including the user's distance from a stationary media location, moving media channels displaying exterior facing signage, or digital billboards that display messaging with the use of digital screens. Further, aspects of the present disclosure allow users to engage with content and receive additional, supplemental content on their mobile device.

### CROSS REFERENCE TO RELATED APPLICATION

This application claims benefit under 35 U.S.C. §119(e) of U.S. Provisional Patent Application No. 61/648,903, filed May 18, 2012, and entitled “Mobile Content Distribution Based on Geo-Location”, which is incorporated herein by reference as if set forth herein in its entirety.

### TECHNICAL FIELD

The present systems and methods relate generally to computer hardware and software systems for extending the location reporting capabilities of mobile devices and vehicle telematics systems, and more particularly to how content is distributed to these devices having been found to be in proximity to advertising messaging shown on outdoor signage at specific locations other than traditionally addressed locations.

### BACKGROUND

Advertising, as an industry, relies on data to substantiate its effectiveness. This data is typically shown in the form of impressions or some confirmation of how many individuals received a marketing message, acted on the message, and how they acted on the message. Outdoor advertising, as a sub-industry, has never been able to deliver data as detailed and concise as other media such as television or digital advertising where impression information is well documented and easily measured. The outdoor industry (OOH) has tried to solve this issue by counting cars that pass by a sign and using survey data from individuals to broadly assume impressions from their signage. Additionally, the industry has used eye tracking technology to see if an individual's retina actually points toward the sign. In any of their attempts to track impressions, there is no information about the individuals, their daily habits, interests, location, or uniqueness. Today's methodologies are strictly count estimates with little to no granularity on the population of impressions outside of generalized demographic assumptions.

The OOH industry (OOH) also struggles to efficiently extend an advertising message beyond the interaction with their sign. In general, many individuals may see a sign but are not likely to act on the message. One such way that advertisers commonly distribute their marketing content to individuals is through mobile advertising, which are websites rendered on mobile devices that provide content in various formats. OOH currently has great difficulty facilitating users to additional information about their advertisers given the messages are print advertisements and occur when the viewer is “on the go.” In most instances, OOH places a URL on the sign, which is a web address for the advertiser's internet page. This requires an individual to recall the URL and utilize their device to find the URL. These URLs are kept short and generic to help the commuter recall the address.

Further, with many location based applications (LBS), the user is often encouraged to view the message while close to the location where the content distribution occurred. Utilizing an LBS and a device, many users today click within the app to access content while still in the area of the retail location. This practice is referred to as a “check-in.” If a user cannot conveniently “check-in” while still within the proximity of the location, they can no longer access that content.

In addition, traditional LBS apps typically require their advertisers to confirm a physical address for their location publication before distributing content to users at that location. Further, these addresses represent, until changed by the advertiser, that advertiser indefinitely. In other words, these LBS apps house locations that are only published as physical addresses for companies that seldom change ownership or tenancy.

Lastly, the OOH industry has found digital signage to be an effective method of distributing messages to users in real time given that these messages are controlled in a computer to computer manner. One shortcoming that remains in this advertising construct is the ability to present messaging that is targeted specifically to an individual or group of individuals that the advertiser is reasonably assured to be in the area or line of sight of the sign.

Therefore, there is a long-felt but unresolved need for a system or method for creating better use of outdoor advertising signage and delivering advertising messages to individuals through both the signage itself, but also a device being used by individuals such as their mobile device or their in-car telematic computer device. Further, there is a need for a system that allows a user to engage with content regardless of proximity to the location that prompted distribution of the content in the first place.

### BRIEF SUMMARY OF THE DISCLOSURE

Briefly described, and according to one embodiment, aspects of the present disclosure generally relate to systems and methods for distributing targeted content to users of mobile devices such as smartphones and other hand-held devices based on the user's geo-location and other user-specific parameters. Generally, the distribution of content may be regulated by numerous indicators including the user's distance from a stationary media location (e.g., billboard, bus stop shelter, storefront advertising, etc.), moving media channels displaying exterior facing signage (e.g., shipping containers, tractor trailers, buses, shuttles, delivery truck, mobile billboards, etc.), or digital billboards that display messaging with the use of digital screens and can be managed remotely to change messaging in real time.

According to one embodiment, the MCDP allows for the efficient exchange of information between outdoor signage advertisers and users of a particular device application. In general, this exchange of information represents the creation of mobile websites by advertisers, determination of appropriate content delivery based on numerous factors, and reverse distribution to digital outdoor signage.

According to one aspect, advertisers may use the platform to house their advertising content, typically in the form of mobile sites. These sites represent content that is distributed to end device users based on a number of conditions having been met. In many cases, but not all, the first condition to be met is the location of a user. Typically, once the user is in the vicinity of a sign, they receive eligibility to see an initial content message. The user may then respond to this content message, thereby causing one of many different mobile sites to then be pushed to the user for their second interaction with the advertiser. This second and ongoing interaction is customized based on user demographics, real time and historical environmental information, and many other factors.

According to one embodiment, the user does not always need to interact with this content immediately after entering the location of the signage. Instead, the user is often given the opportunity to view the message, respond to the message and act on the message (i.e. make an online purchase, share online with others, etc.) whenever it's convenient. According to one aspect, the user's eligibility to view the message will expire, but the user will most often be given at least 24 hours to do so.

In general, the solicitation from the initial content for a user response can take many forms. In many cases, the message will require some form of action from the user in able to gain access to the next message or next mobile page. In one example, this would require a response to a question. In another example, this would require a user to then visit another specific location (often a non-signage location) before then being eligible for the next message. These responses, i.e., “conditions,” must be met for additional and final delivery of content.

In one embodiment, the MCDS allows for messaging to be created by app users as well. According to one aspect, these messages are created by the user on the device, addressed to another personal user and assigned to a particular billboard location. These messages then accompany other platform messages, as applicable, for perusal by the end recipient once that user has passed by the billboard location.

In one embodiment, another form of information exchange between a sign advertiser and a device user involves a method by which message goes in reverse. Given the ability of digital signage to display messages in real time, computer systems that control those displays can be updated real time to present a specific message type. According to one embodiment, the MCDS allows for advertisers to update these digital displays control systems with location information from registered device users. With a user's location information and their personal information, according to one embodiment, advertisers are able to display messages on that digital signage specific to users in an area with line of sight to this sign. Further, according to one aspect, the message can include some level of information about the user so as to make it clear the message is intended for that user. In one embodiment, the location that will trigger an advertiser to push this message will actually be in close proximity to the signage rather than the sign itself As will be understood and appreciated, this technique is similar to the theory of leading a moving target based on where the target is likely to be going.

According to one embodiment, determination of content to be displayed on the digital billboard is often done in real time through existing Digital Out of Home (DOOH) ad exchanges. The factors that help advertisers choose where to place their ads are often based on location and other information about their potential customers in the area of the sign. In one embodiment, the MCDS will provide valuable data to advertisers making decisions about the choice of digital signs and what to display. Additionally, according to one embodiment, the MCDS will provide API access to these ad exchanges so that advertisers may purchase those digital messages in near real time.

Additionally, in one embodiment, the MCDS facilitates individuals to mobile sites that are specifically designed and presented based on a number of factors. As will be understood and appreciated, these factors combine to better target the message to a specific user. In one aspect, these factors include location, message on the sign, weather, time, user demographics within the app, etc. Further, according to one aspect, the MCDS helps to track a user's uniqueness, individual preference, and habits. As will be understood and appreciated, this data can be used in a number of ways to better substantiate the effectiveness of outdoor advertising.

Further, according to one embodiment, the MCDS allows a user access to content for a stated (predetermined) period of time. Whereas traditional LBS apps typically bestow a location-based constraint on this content viewing, in one embodiment, the MCDS first confirms location being confirmed and then constraining the message viewing by time only. This technique may be referred to as “passive engagement” in that the platform application on the device provides “eligibility” to the user without requiring any action by the user at that location at that moment. Further, whereas traditional LBS companies may simply push content to individuals' devices after entering a location, in one embodiment, the MCDS sends a notification, but will often solicit a response from the user that is used to distribute additional content that is customized to the individual response. As will be understood and appreciated, allowing more time (passive) and taking user response into account for content distribution affords more effective content distribution.

In addition, the MCDS allows for publication of signage location based on latitude/longitude coordinates and cross street references, according to one embodiment. Further, in one embodiment, the MCDS allows advertisers to change in real time, thus providing much greater efficiency than other location based applications, as will be understood and appreciated. This is due, in part, to the fact that our locations represent signage assets rather than brick and mortar locations. The “advertiser-as-a-tenant” changes and will inevitably change more often at signage locations than that of a brick and mortar retail location.

In one embodiment, the MCDS is more obvious in the physical world since the locations not only represent a physical sign constructed to be visible, but that the sign will often reference the device application for which they may utilize to receive related content. Traditional LBS applications also utilize non retail locations to push notifications to their app users' devices. These locations are locations where an advertiser believes to be a good location to capture the attention of their app user. If they don't represent retail addresses, they quite often are not represented by any physical asset that can be seen or distinguished by the app user. Advantageously, the MCDS is able to provide some context to these push notifications in that the outdoor sign may represent or correspond with the push notification send to an MCDS app user's device.

Finally, in one embodiment, the MCDS not only reports the location of application users within the vicinity of signage locations, or who are expected to be in the line of sight of a signage location at message delivery time, but the MCDS also allows for real-time display of content on that digital sign that is specific to the user based on factors that also help determine the mobile content at these outdoor signs.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an overall view of a Mobile Content Distribution System (“MCDS”) by which content is presented to device users that are in proximity to billboard locations.

FIG. 2 illustrates an exemplary system architecture of an MCDS, according to one embodiment of the present disclosure.

FIG. 3A is a flowchart illustrating a user registration process by which a user downloads a mobile application for engaging the MCDS onto the user's mobile device, according to one embodiment of the present disclosure.

FIG. 3B is a screenshot of an exemplary MCDS user registration interface (as shown on a mobile device) according to one embodiment of the present disclosure.

FIG. 4A is a flowchart illustrating a mobile device user's entry into a specified region, thereby triggering the mobile application to update with a predetermined listing of content, according to one embodiment of the present disclosure.

FIG. 4B is a screenshot of an exemplary of an exemplary MCDS user engagement listing interface (as shown on a mobile device) according to one embodiment of the present disclosure.

FIG. 5 is a flowchart illustrating a content management platform process by which a system distributes content to a mobile device within range of a billboard location, according to one embodiment of the present disclosure.

FIG. 6A is a flowchart illustrating a content creation module by which an advertiser may create and store custom content on the MCDS system, according to one embodiment of the present disclosure.

FIG. 6B is a screenshot of an exemplary MCDS advertiser business input interface (as shown on a desktop device) according to one embodiment of the present disclosure.

FIG. 7 is a flowchart illustrating an Augmented Reality engagement content creation module by which an advertiser may create and store custom content on the MCDS system, according to one embodiment of the present disclosure.

FIG. 8A is a flowchart illustrating a billboard creation module by which an advertiser may provide billboard information and store that data on the MCDS system, according to one embodiment of the present disclosure.

FIG. 8B is a screenshot of an exemplary MCDS advertiser billboard input interface (as shown on a desktop device) according to one embodiment of the present disclosure.

FIG. 9 is a flowchart illustrating a content distribution module by which the MCDS system distributes customized and targeted content to each user's mobile device, according to one embodiment of the present disclosure.

FIG. 10A is a flowchart illustrating an example of how different billboard locations, content and a basic condition combine to create engagements in the MCDS, according to one embodiment of the present disclosure.

FIG. 10B is a screenshot of an exemplary MCDS basic engagement (as shown on a mobile device) according to one embodiment of the present disclosure.

FIG. 11A is a flowchart illustrating an example of how different billboard locations, content and a click condition combine to create engagements in the MCDS, according to one embodiment of the present disclosure.

FIG. 12A is a flowchart illustrating an example of how different billboard locations, content and a question condition combine to create engagements in the MCDS, according to one embodiment of the present disclosure.

FIG. 12B illustrates 3 screenshots of an exemplary MCDS question engagement (as shown on a mobile device) according to one embodiment of the present disclosure.

FIG. 13A is a flowchart illustrating an example of how different billboard locations, content and a count condition combine to create engagements in the MCDS, according to one embodiment of the present disclosure.

FIG. 13B illustrates 3 screenshots of an exemplary MCDS count engagement (as shown on a mobile device) according to one embodiment of the present disclosure.

FIG. 14 is a flowchart illustrating an example of how different billboard locations, content and a Connect A Dot condition combine to create engagements in the MCDS, according to one embodiment of the present disclosure.

FIG. 15A is a flowchart illustrating an example of how different billboard locations, content and a timer condition combine to create engagements in the MCDS, according to one embodiment of the present disclosure.

FIG. 15B is a screenshot of an exemplary MCDS timer engagement (as shown on a mobile device) according to one embodiment of the present disclosure.

FIG. 16 is a flowchart illustrating an example of how different billboard locations, content and a Augmented Reality condition combine to create engagements in the MCDS, according to one embodiment of the present disclosure.

FIG. 17 is a flowchart illustrating a display distribution module by which the MCDS system distributes customized and targeted content to a digital billboard, according to one embodiment of the present disclosure.

FIG. 18 is a flowchart illustrating a Region Creation Module by which the MCDS system creates updated regions (geofences) based on real time and historical data, according to one embodiment of the present disclosure.

FIG. 19A is a flowchart illustrating a message creation module by which the MCDS system distributes user initiated messages to user's mobile devices, according to one embodiment of the present disclosure.

FIG. 19B is a screenshot of an exemplary MCDS message creation input form (as shown on a mobile device) according to one embodiment of the present disclosure.

FIG. 20A is a flowchart illustrating a display creation module by which the MCDS system distributes user initiated display content to digital billboards, according to one embodiment of the present disclosure.

FIG. 20B is a screenshot of an exemplary MCDS billboard creation input form (as shown on a mobile device) according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

### Overview

Aspects of the present disclosure generally relate to systems and methods for distributing targeted content to users of mobile devices such as smartphones and other hand-held devices based on the user's geo-location and other user-specific parameters. Generally, the distribution of content may be regulated by numerous indicators including the user's distance from a stationary media location (e.g., billboard, bus stop shelter, storefront advertising, etc.), moving media channels displaying exterior facing signage (e.g., shipping containers, tractor trailers, buses, shuttles, delivery truck, mobile billboards, etc.), or digital billboards that display messaging with the use of digital screens and can be managed remotely to change messaging in real time.

### Exemplary Embodiment

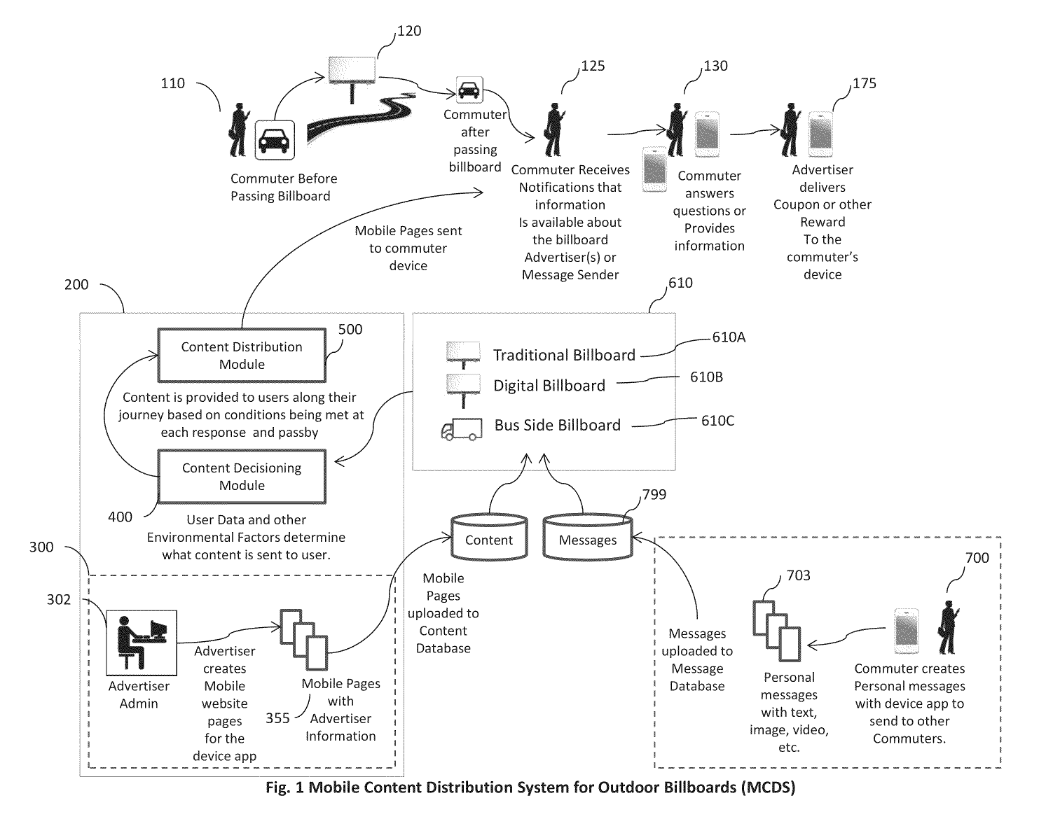

Referring now to the figures, FIG. 1 generally illustrates an overview of an embodiment of a Mobile Content Distribution System (“MCDS”) in an exemplary environment, constructed and operated in accordance with various aspects of the present disclosure. As shown in FIG. 1, the MCDS is configured to engage with certain components of a commuter's ride to work. According to the FIG. 1 embodiment, in addition to the commuter, those components may include the commuter's mobile device, one or more outdoor media signs (alternatively referred to herein as “billboards”), and one or more mobile web pages (alternatively referred to herein as “content”). As will be understood by one of ordinary skill in the art, though not shown in the FIG. 1 embodiment, the MCDS may engage with additional components such as reverse Wi-Fi router signal location devices and any manner of outdoor signage as is described in FIG. 1 components 610A, 610B and 610C. According to one embodiment, the MCDS's engagement with the components allow a commuter with a mobile device to view and interact with mobile device multimedia content that is specific to a particular billboard location, a particular user, and certain other environmental factors that may exist at the time of the trigger (i.e., the mobile device user's entry into a particular area that entitles the user to receive certain predetermined content). In one embodiment, these specific factors constitute criteria by which the MCDS is able to target messages to different subsets of users.

As shown in the FIG. 1 embodiment, the MCDS typically interacts with three primary types of billboards. The first is a conventional, free-standing billboard. As will be understood by one of ordinary skill in the art, this traditional billboard may exist in various sizes and shapes, but the common characteristic of this billboard type is that it is a fixed media, whereby it is generally a permanent structure. In general, such conventional, free-standing billboards comprise the majority of the billboards with which the MCDS interacts, though in certain aspects, the MCDS also interacts with temporary signs. In general, messages on such conventional billboards are printed and typically, the messages are not changed more frequently than once per week.

The second billboard with which the MCDS interacts is a digital billboard, as shown in the FIG. 1 embodiment. Typically, digital billboards exist in various sizes, provide messaging through LED lights (or similar lighting technology) and in certain embodiments are capable of changing messages as frequently as once per second. Finally, as shown in the FIG. 1 embodiment, the third billboard with which the MCDS interacts is a billboard that regularly changes location, which are often called “transit advertising signs.” Often, as will be understood by one of ordinary skill in the art, a “transit advertising sign” refers to a sign that appears on a vehicle, e.g., on the side of a metro transit bus, on top of a taxi cab, on the side of box trucks and/or semi trucks.

According to one embodiment, an MCDS is comprised of several elements that constitute different outcomes depending on the arrangement of these elements. As described above, the primary elements involved in the MCDS can be used in more than one way and may be used in different manners, depending on time, location and condition.

The beginning of FIG. 1 begins with a user and a mobile device 110. In one embodiment, the system is designed to provide mobile content to users in and around any commuting route or path. Additionally, the system is designed to accommodate content distribution to commuters of any modes such as walking, bus, subway, driving, train, and other mode that offers access to a network connection (Internet) either during their commute or sometime after their commute.

One exemplary situation where the system is useful is on an interstate where a user and device might drive and there are billboards (or other outdoor media signage) along the side of the interstate. Another example of a useful situation is where a user is waiting for the subway train at the platform where there is outdoor signage. Another example may be where a commuter is riding in a bus or train into a metropolitan area where there is visible outdoor signage on the side of the route. Another example would be a user and device travelling down a sidewalk of a college campus where a college administered bus passes by and displays an outdoor sign on the side of said bus. These examples, for the most part, exemplify situations where any user and their device might be subjected to or in the line of sight of any manner of outdoor media.

With an established view of the surroundings of a typical environment for the primary system user, it is also understood that there may be multiple types of outdoor signage that all apply and are accommodated by the MCDS. One of these types of signage is shown in FIG. 1 as a traditional billboard 610. A traditional billboard itself can take many forms, but typically share a few common characteristics. One such characteristic is that these signs are permanent, in that they are placed into a fixed location in the ground or other permanent foundation, and are not intended to change location. Typically, these fixed locations allow the system to locate their exact position utilizing latitude and longitude coordinate combinations and store them a database with little concern for their location changing. These billboards are traditionally constructed with either wood, metal, or a combination of the two. With a firm frame, the billboard message displayed are either tightened to the frame with printed vinyl scrims, plastered with glue and paper printed forms, or painted individually onto a permanent surface.

Digital Billboards 610B are very similar to the description of the traditional billboard except for they are constructed of metal and do not have vinyl, paper or painted surfaces. Digital billboards create digital images on their surfaces utilizing a large number of individual light bulbs, an assembly of LED panels, and other display technology not unlike that used in televisions. In many cases these displays create messages that are in High Definition (HD). These messages are changed by a computer which is centrally provided by a software entity, but locally managed by the particular licensee of the software for the purposes of managing that particular billboard. As is described later, the system is capable of creating and delivering messages and advertising copy to these computers.

The third billboard type is a Transit Billboard. These billboards are continuously changing locations. These billboards are most often affixed to a truck, container, bus, or train. The signage is most often vinyl, but could be digital or painted. The most frequent examples of these transit billboards are those found on the side of metro area transit buses. Other examples include college campus transit system busses, subway train vinyl wraps, dedicated mobile billboard vehicles, and the adhesive vinyl signage that is commonly found on the trailer of Less-than-truckload (LTL) and Truck-Load (TL) carriers that commonly distribute goods on highways each day. For the system to recognize and integrate the appropriate content associated with these signs, the transit vehicle owner or operator entity must provide a location reporting Application Programming Interface (API) for which the MDCS can communicate. These APIs are typically found in metro authority systems, college transit systems, LTL/TL Carrier systems and more. In general, the MCDS system utilizes the persistent availability of those locations to report the location of these signs to the MCDS region and content management systems.

With the backdrop of a user device, a particular billboard type and applicable situations of the two, one would now look to how these two components interact with the MCDS. FIG. 1 shows an overall environment 101 in which, in one embodiment, a user interacts with the system using a mobile device 110 and a billboard 120. In this example, the billboard could be digital, fixed or transit. In any event, the location of that billboard is known to the MCDS. Considering the location of the user device, the MCDS recognizes when that location matches or comes within an appropriate proximity of a billboard. When those locations are close in proximity to each other, a trigger occurs, according to one embodiment. In this example, once the user passed by the billboard 120, the trigger occurs and the MCDS is then prompted to take action.

According to certain embodiments, various other triggering methods can be utilized to prompt the MCDS to take action. According to one embodiment, near field communication (NFC) may be utilized to affect a trigger. In this instance, NFC is acting as a substitute to the traditional geofence and location validation process. Generally, when NFC is utilized, it requires a reciprocal incorporation of technology on the billboard (or other outdoor media), which is generally a sensor. In the case of the MCDS, the user would wave their device near the sensor on the sign and this action would create a trigger necessary to begin content delivery.

According to an alternate embodiment, another instance where NFC could be used instead of the network would be include the sensor detection function as a possible condition for content distribution. For instance, the system could accommodate an engagement template whereby the condition required for final content would be waving a user device near a sensor. In most cases, this sensor is identified as being on the billboard.

As will be understood by one of ordinary skill in the art, for any use of the carrier network for access to location information or content delivery over the internet, Wi-Fi, NFC, or Bluetooth technologies may well be used in one or more of these capacities if deemed most efficient or appropriate.

In the FIG. 1 embodiment, that initial action by the server is to fetch the information about the advertiser of record on that specific billboard, fetch any associated content on the server from that advertiser and deliver one of many potential content options to the user sometime after the trigger has occurred. Typically, this will happen within seconds, as seen in this embodiment. As noted previously, this content refers to mobile webpages that were constructed and uploaded to the MCDS by advertisers. Advertisers author numerous pages with varying uses of art and messaging to accommodate many different types of customer subsets or demographics.

In one embodiment, for each billboard face or message, the MCDS will have one initial content page. These content pages always represent directly or indirectly the messaging or advertising context that was associated with the outdoor billboard. This allows the user to draw mnemonic connections between the outdoor message and the content to be viewed on the mobile device. Advertisers produce several pages of content for each face so that the most appropriate page can be presented to the user based on a criteria. This criteria can be complex within the MCDS, but FIG. 1 indicates no such criteria. In other examples, content is matched to users based on demographics and environmental factors at the billboard location at that time.

In one embodiment of the MCDS, the content that is made available to the user after passing by the billboard is presented to the user's device as a silent download of a listing or the device receives a push notification that alerts the device user. The mobile application allows a user to easily program notification options to their needs. This binary option will allow the system to suppress alert notifications at the mobile operating system level. The listing is accessible and viewed once the application is brought the foreground. This listing represents all content available for each outdoor sign the user has passed and triggered.

The user may view the initial content page of any one of these listings by clicking on them on the device. Upon clicking the content, the server provides the content as a viewable mobile web page 125, as shown in the FIG. 1 embodiment. According to one aspect, the MCDS notes that a user is provided access to this listing by virtue of the trigger process or by passing by the billboard location. This access to the listing persists until some stated expiration, which is labeled and obvious to the user. This expiration can be changed by the advertiser to appropriately coordinate with the specifics of the content and the conditions of the engagement. This ability to engage with this location based content later (at any location thereafter) is herein referred to as passive engagement. Content messaging built and housed in the system will not typically, while still an option, encourage a user to view the content immediately after affecting a billboard trigger. In accordance with commonly accepted highway safety standards, the system utilizes the passive engagement functionality to remove any perceived incentive for a user to view content while driving in a vehicle immediately following a trigger event.

In one embodiment, delivering content is not the end of the MCDS engagement process. In one embodiment, the advertiser has created additional content beyond that of the first page. While the first page is tailored to a particular user, the remainder of the content delivered to the user is conditioned upon the actions of the user from there until the engagement has provided final content.

As will be understood and appreciated, the use of conditions in the system serves to provoke action, using the device, on the part of the user. These actions indicate to the MCDS that a user is has been encouraged or motivated to do so by the advertising message on the billboard and/or the initial content delivered to device. According to one aspect, conditions represent any messaging-and-action validation process that may apply to a user. The action validation process is most likely to be measured by the device itself, but may also be measured by other devices at areas controlled or affiliated with the advertiser or the system.

Conditions can vary and may be integrated into the system anytime and any location. These conditions are housed in the Content Management Platform 200 along with the remaining mobile assets that combine to produce engagement content pages, according to one embodiment. Some conditions may include location, successive location, text response, voting response, examination response, device movement response, timing based response, etc. The messaging, in most cases, will detail the condition that is being requested and to be validated.

In the FIG. 1 embodiment, the condition is a question whereby the user answers it or provides some level of information 130. The response to this condition is performed and recorded on the device, in one embodiment. The response itself is uploaded to the MCDS upon user submission, according to one embodiment. Once confirmed by the server, the user is then able to receive final content 175. In the FIG. 1 embodiment, the final content is a coupon or reward that will remain housed in the application and on the device until redemption (or activation expiration) at a later date.

Though not shown in FIG. 1, in other examples, the MCDS would accommodate numerous conditions within one engagement and any combination of elements imaginable to create a customized, passive engagement style distribution of content to users that are in the line of sight of outdoor signage.

In one embodiment, content (and their corresponding conditions) are built and recorded to the MCDS's content database using a front end application. Generally, this front end application is where an advertiser administrator can build all aspects of their system engagement 300, including their choice of billboards, text, art, colors, conditions, number of pages in the engagement, inclusion of a secondary location (most often a retail location), and more. Typically, these elements of information are housed in the content management platform 200. According to one embodiment, certain portions of the Content Management Platform perform s specific functions. For instance, in one embodiment, the Content Decisioning Module 400 is where targeting computations take place for each content engagement and user interaction. In this module, factors such as weather, time and traffic can be fetched in real time to match the appropriate content options created by the advertiser at the very moment content is made available to a user after a billboard trigger, according to one embodiment.

One example of the use of this information could be the distribution of a beverage coupon by retailer. User data utilized within the decisioning module might include gender. Environmental data used by the module might include temperature and time of day. With the combination of this data, an advertiser's content that was created specifically for a female, at warm temperatures, in the afternoon could be distributed to that user.

Conditions represent another form of targeting for content messaging in that the variation in user responses to a given condition may provide equally varying content pages. In this example, the answer to a simple question may vary among four distinct responses by a user. An advertiser could very well produce one of four distinct content pages to be delivered to the user that is specific to their response.

While much of the MCDS will be utilized by advertisers on billboards, according to one aspect, the MCDS also accommodates the use of user-authored messaging within the application and its users 700. More specifically, in one embodiment, users of the app may create content for the application device. While these users will not likely be purchasing traditional billboard space to augment their content creation, they may utilize billboard locations housed in the system to “location address” these messages. To “Location Address” in this sense is to choose a billboard by which a user must trigger to receive the message from the user-author. A publishing user must choose both a recipient (by e-mail address or system username) and a billboard location. These messages are capable of including any form of multimedia messaging such as text, images, video, etc., according to one embodiment.

While the above embodiment describes the use of messages being distributed to other users by user-authors, another embodiment includes the ability of a user-author to create messaging that is displayed on a digital billboard. Similar to the ability of an advertiser Admin to create digital messaging that is scheduled to be displayed on a digital billboard via a software program, a user may use the device application to create a message and submit to the MCDS. The user-author doesn't need to trigger a location to publish these messages and may publish by desktop computer or mobile device, according to one aspect. In any event, the message is submitted to the MCDS and is scheduled to be displayed on particular digital billboards of the user-author's choice.

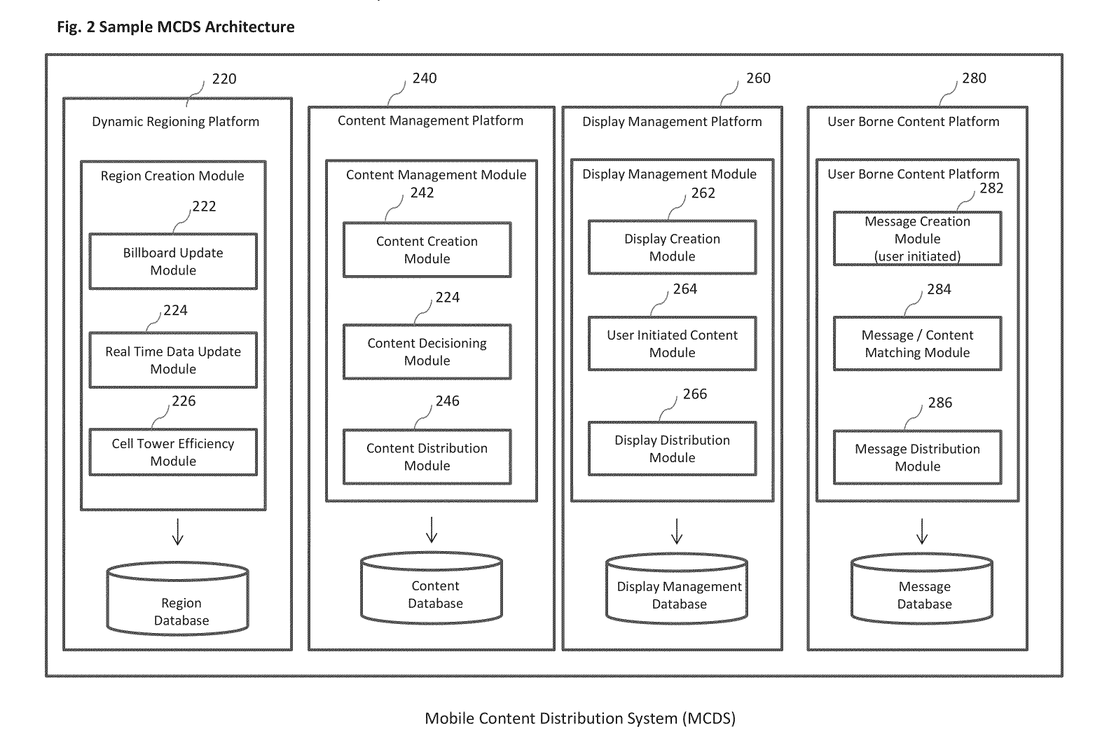

FIG. 2 illustrates an exemplary system architecture for an MCDS according to one embodiment of the present disclosure. The system is further described by platforms that combine to perform many functions for both the benefit of the advertiser and the user. The system allows information to flow to and from users and the system, allowing distribution of messages to user devices and digital billboards.

As shown in FIG. 2, a Content Management Platform 240 manages the delivery of initial and successive content to the user. This platform represents the beginning of an engagement process with the system where an advertiser creates content. In one example, this platform is updated by the user of a front end application. In this example, both advertiser and system administrators have access to update information. In the content creation module 244, the advertiser creates content, assigns a billboard, establishes conditions, and activates a campaign, according to one embodiment. In one embodiment, environmental factors and data about the location that impact the choice of content to be delivered are computed by the Content Decisioning Module 246. Typically, conditions and potential options of content distribution are written and accomplished here. The computation of what content is provided to a user based on conditional responses generally occurs in the content distribution module 248.

As shown in the FIG. 2 embodiment, a Display Management Platform 260 represents how advertisers can initiate messages and schedule those messages to be displayed on digital billboards in several capacities. Most traditionally, an advertiser can use the MCDS to quickly find an application user, extract information from that user out of the use database, and use that information to personalize a message scheduled to display on a digital billboard where that user is likely to be located. According to one aspect, another use of the display management platform is to house and distribute messages on digital billboards that were created by users. In the FIG. 2 embodiment, the Display Creation Module 262 represents the MCDS's front end application used by advertiser administrators to create both digital display messaging artwork, but also create “leading” triggers. According to one aspect, leading triggers are locations that don't represent a billboard, but a location that a user is likely to pass just before being in line of sight of the subject digital billboard. Once this message is created and a trigger is defined, the delivery of this information is done through the Display Distribution Module 266, in one embodiment. Typically, the Display Distribution Module connects the MCDS to computers and software (via API) that control scheduling and message creation for digital billboards. In some cases, this module may also be connected to a real time buying exchange platform where an administrator or the system itself (with programmatic logic defined by an advertiser) could choose the subject digital billboard based on a combination of user location awareness, billboard price and billboard availability.

An additional function within the Display Management Platform is the user initiated content module 264. In one embodiment, this module provides an interface (both on desktop and mobile devices) for application users to create and schedule messages on digital billboard of their choice. This interface allows for the creation of a multimedia message, preview of that message, payment for message scheduling and passing of the message content to the Display Distribution Module.

Another module in the FIG. 2 embodiment is the User Borne Content Platform 280. In one embodiment, this platform is where non-display, user created messages are housed and managed. The MCDS allows for an application user to create a custom message that includes text, images, video and more and send it to another user registered with the application. The sending user not only addresses the message to a another user, they must also assign a billboard by which the recipient user must pass to receive the message content. The receiving function is not unlike the user engagement, but the message is constructed by an individual user rather than by an advertiser on the system platform. The first process within this platform is the message creation 292, in one embodiment. Generally, this interface (either desktop or mobile) allows a user to create a message. The system creates a record for this message and passes it to the Message/Content Matching Module 284, according to the FIG. 2 embodiment. This matching module updates the content database with messages that are to be displayed along with other advertiser content.

The last platform in the FIG. 2 embodiment is the Dynamic Regioning Platform 220. In general, this platform exists to combat the inherent mobile device operating system challenges with tracking location and reducing excessive battery drain. In instances where battery drain is an issue, the MCDS organizes its billboards into regions. Therefore, rather than a 1:1 ratio of billboards to geofences, the MCDS houses regions that have a least one billboard but may have a plurality, according to one embodiment. The Dynamic Regioning Platform generally utilizes data from the user device at the time of passing, traffic pattern data, and other environmental factors 224 that impact the assumed performance of the location manager function on any given mobile operating system to change the size, shape and placement of regions that contain billboards. In one embodiment, this dynamic change occurs to reduce the need to excessive location calls and ensures accuracy for the user's eligibility to receive content from the advertisers specific to those billboards passed by the user, as will be understood and appreciated.

According to the FIG. 2 embodiment, the billboard update module 222 is where billboard records are updated to reflect the region in which they reside. The real-time data update module 226 is computational module that pulls information from various computer-to-computer connections for environmental information such as weather, traffic information, etc., according to one embodiment. Additionally, the Cell Tower Efficiency Module 226 is static data that is referenced by the Region Creation Platform when computing the most appropriate size and location for the new region, according to one embodiment.

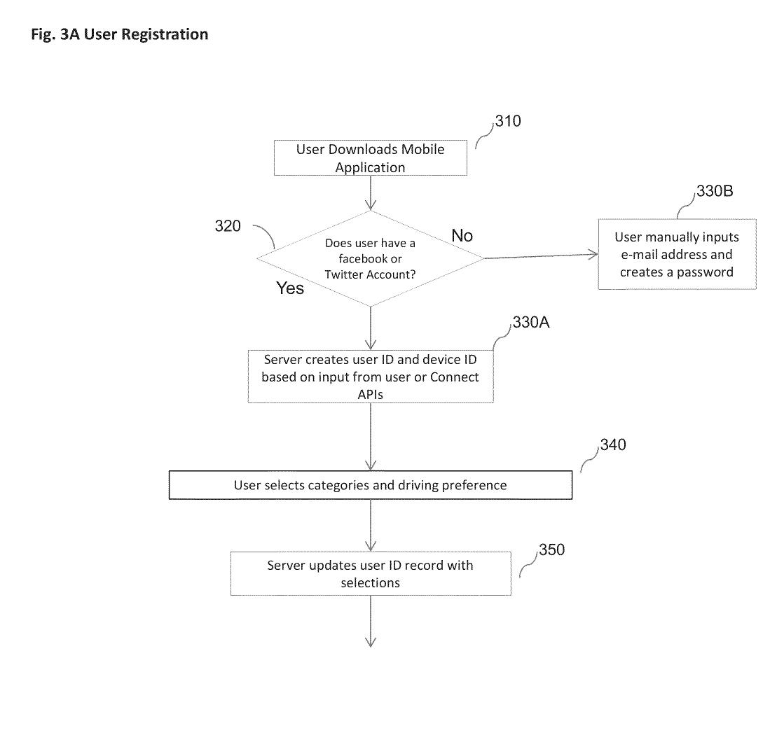

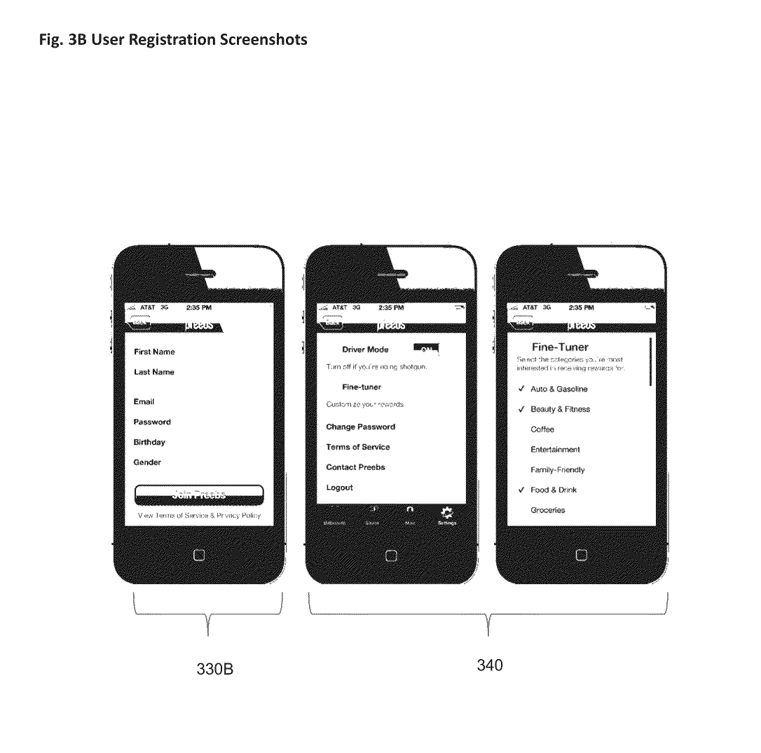

As discussed in relation to FIG. 1, according to one embodiment, a user begins the process of engaging with content on the MCDS by downloading an application onto their mobile device. According to one aspect, a user locates and downloads the application by using a popular “app stores” such as those administered by Apple or Google, as will be understood by one of ordinary skill in the art. FIG. 3 illustrates an exemplary process by which a user locates and downloads the mobile application and creates an account within the MCDS. As shown in FIG. 3, once the user has downloaded the application, at 310, the MCDS determines whether the user has an account with an application that may provide sign-on functionality through an API process, e.g., Facebook or Twitter account at 320. According to the process illustrated in FIG. 3, if the user does not have an account that allows for sign-in to the application via an API process, the user may manually register with the MCDS, at 330B. In one embodiment, the user provides information such as an email address and a password to create an account within the MCDS. According to one embodiment, if the user utilizes an API sign in (e.g., Facebook Connect), the user will not need to enter an e-mail address or password. The use of these API sign in components retrieve information from a user's profile built into another application. To the extent the user has created a profile and the API sign in component provider allows for sharing of this profile information, the MCDS will import this information and store it under the UserID record as will be understood by one of ordinary skill in the art. Upon importing such user-related information, at 330A, the MCDS generates a user ID and mobile device ID, both associated with the user. As will be understood, according to one embodiment, the MCDS generates the user ID and mobile device ID in the same manner irrespective of whether the user information is inputted manually by the user or is received via an API call.

According to the FIG. 3 embodiment, after initial registration, at 340, the user will be able to provide additional demographic information about themselves, including information such as sex, age, annual income, and other identifying demographic information. As will be understood and appreciated, such information is useful in determining targeted content for the particular user. Further, in the FIG. 3 embodiment, at 340, the user can select the types of content with which the user is interested in being presented and viewing. The system allows an advertiser to assign categorical values to their content messages. These values might include examples like groceries, gas, entertainment or automobiles. The selection of categories allows the system to effectively filter what content is distributed to the user device. According to one aspect, the MCDS will only show selected categories to the user during their use of the MCDS application.

According to a further aspect, the user may choose to utilize a driver mode function, which is a binary option that asks the user if they are driving. In one embodiment, this preference determines whether the MCDS will provide push notifications with sounds and alerts to the user while the user is driving. In addition, in one embodiment there is an option for the user to specify their power source, which allows the user to indicate whether or not the mobile device will have access to plug-in power or will rely solely on the mobile device's battery for power. In one embodiment, the MCDS utilizes this data to determine the accuracy level of the GPS reporting in the mobile device Operating System's location manager. According to one aspect, when a user selects plug-in power, location manager accuracy is boosted and the device may rely less on dynamic regioning. Further, as will be understood by one of ordinary skill in the art, by utilizing plug-in power, the likely billboard:geofence ratio approaches 1:1. In one aspect, where the application is downloaded as a telematic, in-car system, the MCDS assumes the power meter to be plug-in, and accuracy remains high at all times. FIG. 3B illustrates screenshots of the system application interface. First, a user may input or update their profile information, in 330B. Secondly, preferences specific to that user may be updated by selecting the categories, as explained above, and telling the system whether or not the user is likely to be driving or not. Once a user is registered, the application can run in both background and foreground modes. This allows a user to perform normal functions on the device and the application still works to report locations efficiently without interruption.

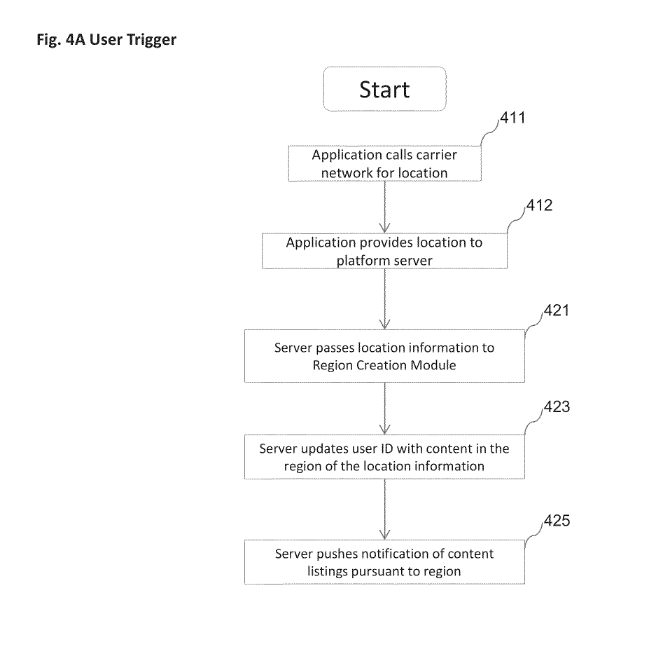

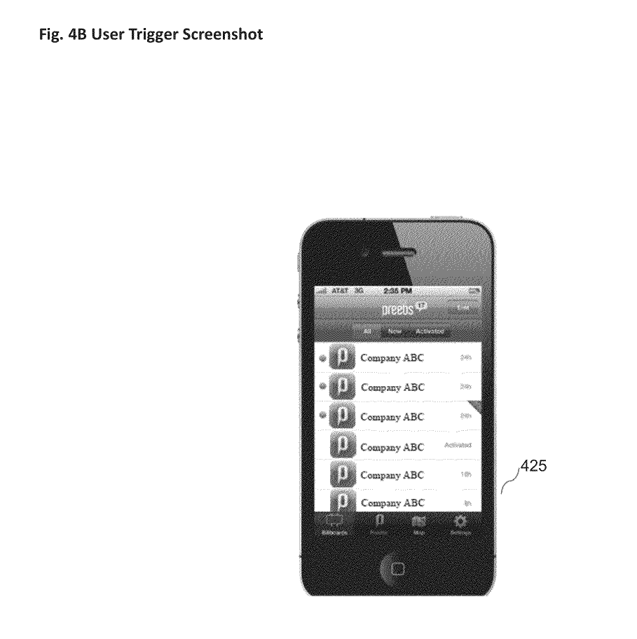

FIG. 4A illustrates how a user must first come within line of sight or within range of a billboard that is recorded in the system. Once a user has passed by this location (aka Trigger), generally signified by a billboard or other signage type, a listing will populate on the application 425 representing the options of content available to the user. A trigger can be defined, for the purposes of these descriptions, either by the location of the subject billboard or the action of passing by the billboard in discussion.

The process described herein begins with the device, while connected to a wireless carrier network (or other internet connection, such as Wi-Fi), requesting current location information 411. Once the network returns this information, according to the FIG. 4A embodiment, the application passes this to the MCDS, at 412. Typically, the MCDS then populates this location information into the region creation module 421. Once the region is confirmed, the UserID record is updated to reflect that location information 423 for purposes of determining what content that user is now eligible to view, according to the FIG. 4A embodiment. Generally, the MCDS will then distribute a listing of this content 425.

FIG. 4B illustrates how a listing might be rendered on a device. This list will, in most cases, remain unchanged without user interaction for the stated period of expiration (typically 24 hours) dictated by the advertiser. A user may click and view this content anytime and at any location before the period of expiration lapses. If the user clicks on any content, mobile pages designed for that billboard advertiser and the specific characteristics of the user are displayed, according to one embodiment. Each listing may be deleted, in which case the user can and must pass by the billboard location again to gain access. This summarizes, at a high level, the most general usage pattern of this passive engagement and conditional content distribution based on billboard location and relative messaging.

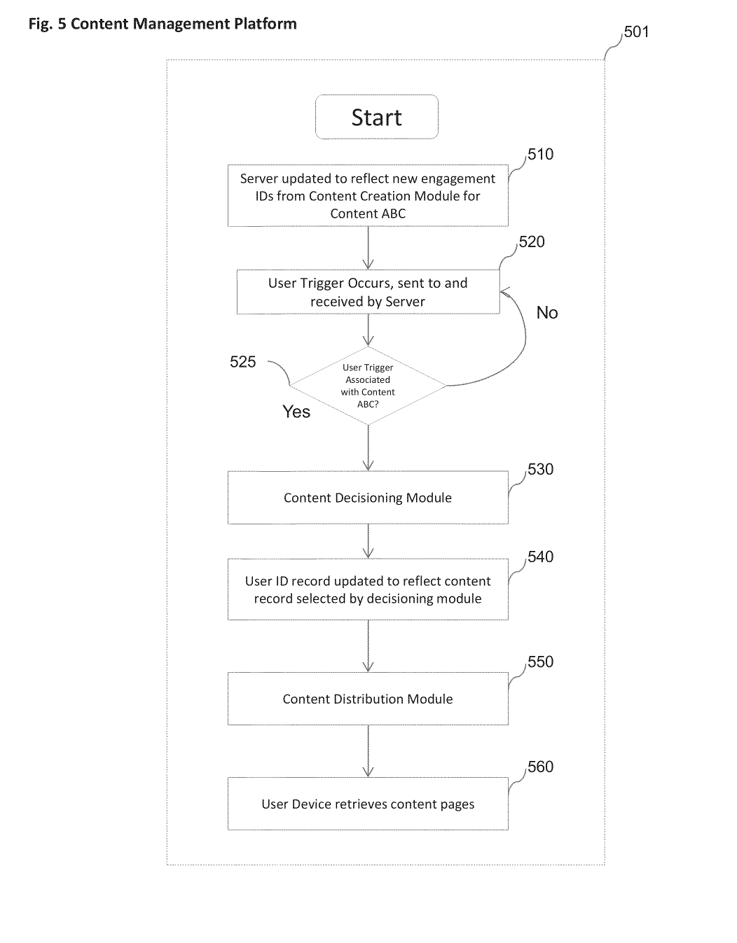

FIG. 5 shows a summary of the content management system, which incorporates the Content creation Module, the Content Decisioning Module, as 530, and the Content Distribution Module, as 550, according to one embodiment. Once an advertiser has utilized the front end application to create their new engagement content, the server records a new Engagement ID and content record 510, as shown in the FIG. 5 embodiment. In FIG. 5, this example content example is called ABC. If a user triggers the billboard for Content ABC 525, then the content decisioning module will then match and determine what content pages are to be distributed to the user 530. When this computation is completed, the user ID record on the server is updated to show eligibility for the page Content ABC 540, according to the disclosed embodiment. Lastly, the content distribution module is updated from the device upon conditions being met by user and device actions taking place during and after trigger point(s), as shown in 550. Once conditions are met, the content distribution module updates the user ID record to show that the content page may now be delivered upon request, in 560.

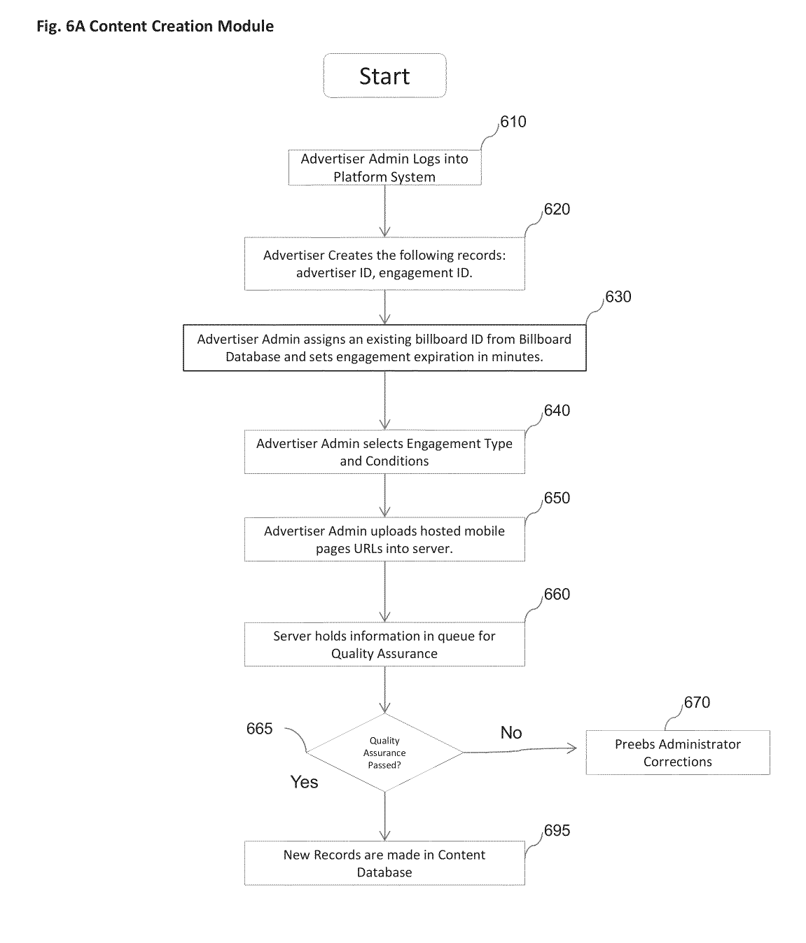

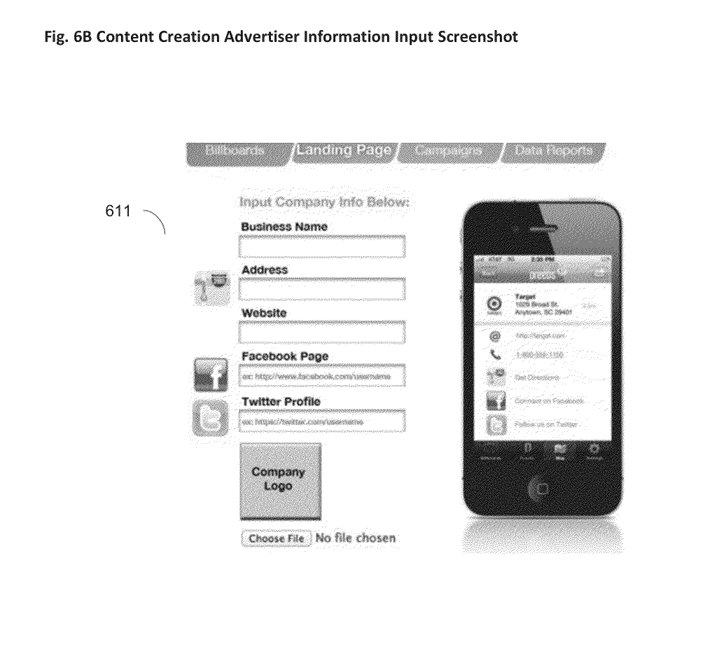

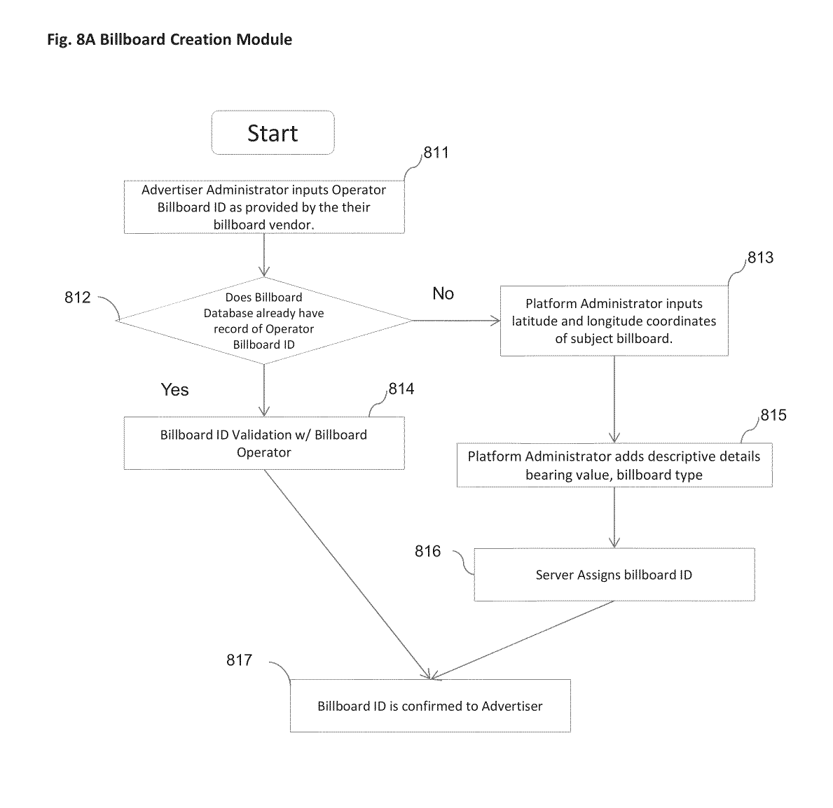

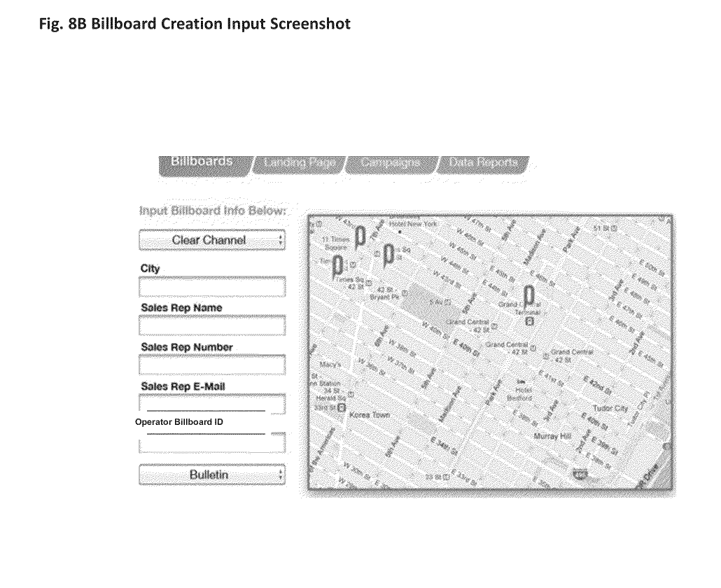

FIG. 6A represents the process by which an advertiser administrator utilizes a front end application, running in correspondence with the MCDP system, to create content to be delivered to devices, according to one embodiment. This module begins with the advertiser administrator registering with the MCDS. Subsequently, in one embodiment, the server assigns new Advertiser ID and creates a new record. The advertiser may then log in, as in 610, create an engagement, where once concluded the server assigns an Engagement ID and creates a new record 620. The advertiser may then use one of several methods of choosing a particular Billboard ID to be associated with the engagement content they are creating, in 630. One such method would be to input a Billboard Operator ID. In this case, the server may match to a record of similar ID in the existing database. If not existing, in one embodiment, an administrator would manually create the billboard, as shown in FIG. 8. An alternate method for assigning a billboard would be to utilize a mapping application within the platform that displays pictorially the existing billboards available for selection. The advertiser administrator would choose a point on the map to select a billboard.

According to the FIG. 6A embodiment, the next step for the advertiser administrator is to select the details of the engagement. First, the advertiser administrator chooses an engagement expiration, which corresponds to how long the content will be available for that particular billboard, according to one embodiment. This expiration will typically match the period of time the advertiser has contracted to display a message on the selected billboard. Further, an engagement type must be selected, shown as 640. This can vary significantly from pre-existing templates available to the user or to create custom engagement scenarios. Along with the selection of engagement type, the user will determine the conditions that accompany the engagement content. These conditions are housed and confirmed within the content distribution module, according to one embodiment.

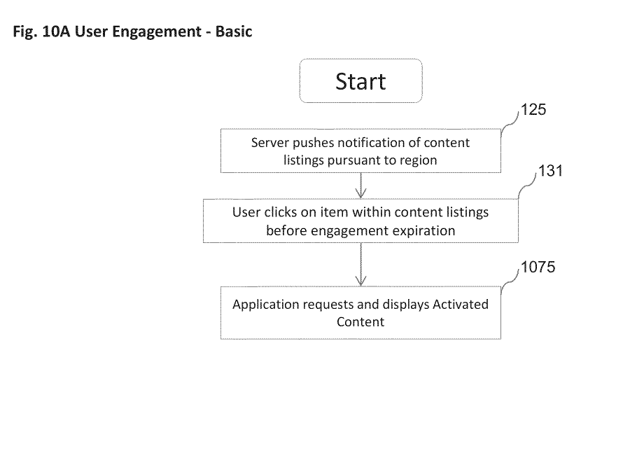

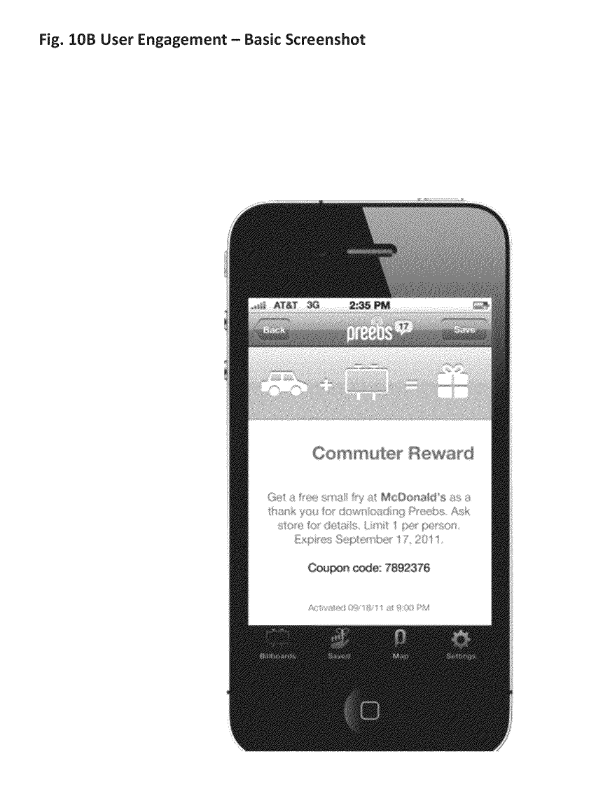

As previously discussed, conditions are those actions required by user to view content for any given engagement created by an advertiser. As further discussed, the method of these conditions may vary. In one embodiment, conditions utilize the many functions inherent in mobile device operating systems to acknowledge and confirm actions by the user. Alternately, other conditions may be set based on the user interaction and personal responses of that user, regardless of the technology being used. Further, some conditions will combine mobile device operating system technology with the custom responses of a user. The examples shown in FIGS. 10-16 illustrate how conditions are utilized to withhold content delivery until they have been satisfied.

Once this information has been supplied for this particular content record, according to one embodiment, the advertiser will upload certain artwork that will be displayed on their content pages for the engagement, as in 650. This artwork can be used in a piecemeal manner where a pre-existing template is populated. This process is commonly referred to as “self-serve ad” creation, as will be understood by one of ordinary skill in the art. Alternatively, the advertiser administrator may upload URL links where that advertiser has pre-existing mobile pages hosted outside of the system for the purpose of the engagement, which could be referred to as custom content pages. According to one aspect, some level of quality assurance will take place by the system administrator in 365. Once that is approved, the system will create new records to reflect the content, in 395.

The distinguishing factors used in targeting a specific subset of the user population may include, but are not limited to, age, sex, current location, previous location patterns, weather, traffic patterns, advertiser sales data, and many other factors that may be relevant to the user at the time they are engaging with the content. In any case, the messaging on the billboard that provided access to the content will generally be a factor included in delivering content. One simple example of this is a retailer that sells cold and hot drinks at several retail locations. The user's location may dictate what retail location is listed on the content, weather may dictate what type of beverage is advertised and an optional coupon may be presented if the retailer's sales data indicates they have undersold that product that day.

FIG. 6B shows an exemplary screenshot of a desktop interface whereby an advertiser administrator could add information about their business while creating content.

The following embodiments illustrate examples of content engagement that advertiser may choose to utilize that require customized programming, according to one embodiment. In those instances, the MCDS's foundation is utilized to create additional examples, such as those that follow. In other instances, there are software platforms external to the MCDS that may be required to fully execute a customized engagement.

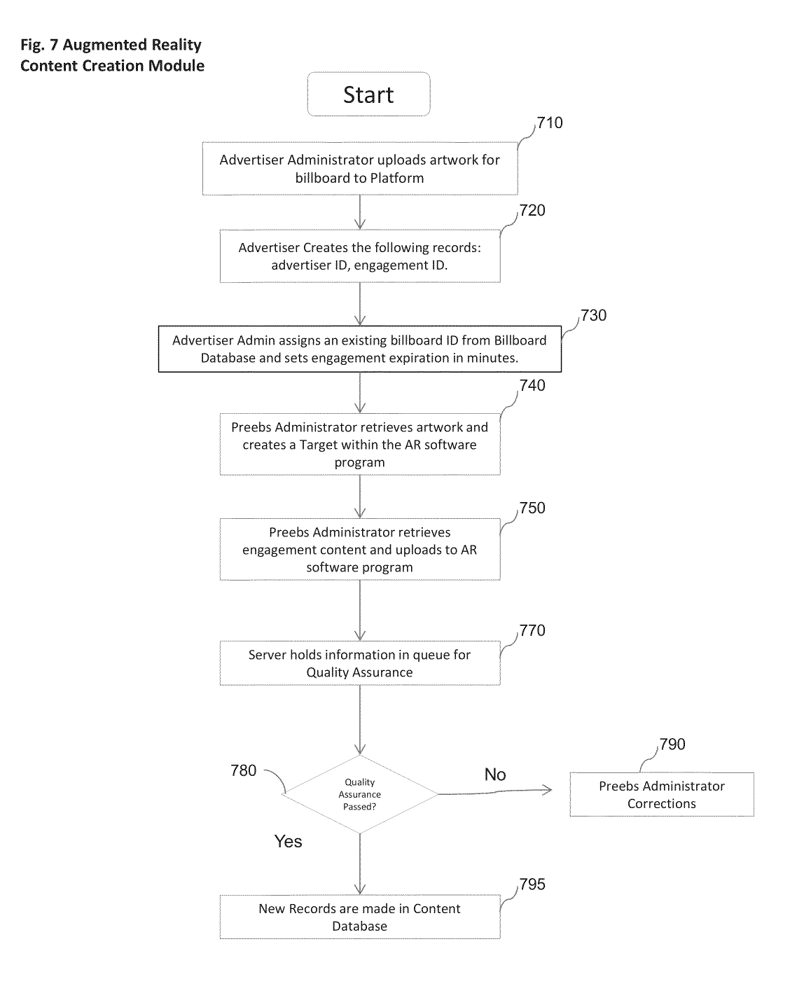

One such example is creating an augmented reality (AR) engagement, as shown in FIG. 7. According to one embodiment, the advertiser begins the creation of an AR engagement by uploading files of the artwork (i.e., target) that will be printed and displayed on the billboard associated with the engagement 710. At 720, the MCDS creates records in the content management database, according to the FIG. 7 embodiment. As with other engagements, the advertiser generally assigns a billboard ID and creates an Engagement ID 730. Once the advertiser administrator has completed their campaign creation, the Platform Administrator generally uploads the target to an external AR software program, as in 740. The MCDS or the administrator will also need to update the AR software with the content that the advertiser would like to be rendered 750. As in any content creation, a system administrator typically will review content before being released 770. Once approved, as in 780, the MCDS will update the content database with the newly created IDs. When users begin to call the information specific to these engagements, the application will utilize this software provider's toolkit to pull down custom content in a manner consistent with Augmented Reality tools in the marketplace, as will be understood by one of ordinary skill in the art.

As noted previously, in one embodiment, the content that is available to the user generally is available for a predetermined period of time, most often 24 hours. This allows for the user to engage with or view the content when convenient for the user. There is no need to view or engage with the mobile pages at the time the user is located within the billboard region.

In one embodiment, the MCDS allows for distribution of content to a user who has been definitively co-located in the vicinity of a billboard and has likely seen a specific message. The message is known to the system and the engagement content is likely related and/or is an extension of the message. The following are examples of how the MCDS works with different conditions and how different responses can determine different final content.

Billboards are key component to the completion of a mature engagement, i.e., an engagement that has all necessary components to be recorded and active for users to engage with. In one embodiment, the MCDS houses a billboard database with information such as Latitude, Longitude, Size, Bearing (i.e. facing North by Northwest or degree measurement), and type (i.e. digital, traditional or transit), as previously discussed. If an advertiser would like to utilize a billboard that is already housed within the database, they may use one of several methods of selecting that billboard, according to one embodiment. According to one aspect, an advertiser may submit the Operator Billboard ID 811, which is an ID supplied to the advertiser by the Billboard owner and this ID is associated with the operator's internal indexing system. An alternate method by which an advertiser administrator could select a billboard is by utilizing a mapping function within the platform front end web site. According to one aspect, this map program would display, with only broad accuracy, locations of billboards that are available to the advertiser and are housed within the existing billboard database. The advertiser administrator could then select these points on the map. The server would record the billboard ID associated with that icon on the map and record it as the selection of that advertiser, according to one embodiment.

In the instance where a new billboard is utilized and is not reflected in the current billboard database, the system administrator will manually input location information and create a billboard in the MCDS, at 813. In this case, the MCDS assigns a new billboard ID, as in 816. According to one embodiment, the server would associate and match this ID with the existing billboard database. The MCDS would also validate the relationship with the advertiser and the operator, at 814, according to one embodiment.

FIG. 8B shows a screenshot, as seen on a desktop interface, of the billboard selection process, according to one embodiment of the present disclosure.

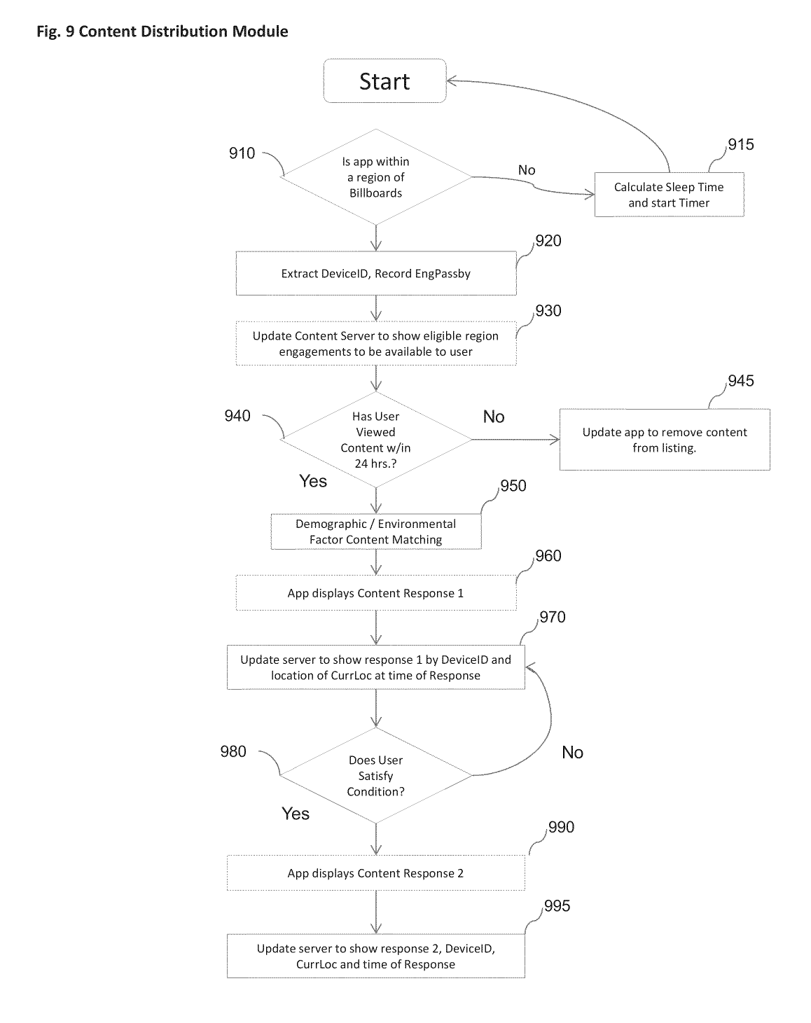

The housing of conditions and environmental factors is the Content Decisioning Module (FIG. 9). The Distribution Module applies the appropriate content page to the user at the time of engagement, according to one embodiment. This module properly updates the server databases to reflect what content was presented to users. Additionally, according to one embodiment, the content is typically of familiar scheme, aesthetics or context with the billboard message. As will be understood and appreciated, this is a differentiator of the MCDS to present content specific to geocoordinates within two-meter accuracy that is related to a message found in the physical realm, in this case being a billboard sign and message.

The content distribution model, according to the FIG. 9 embodiment, shows the flow of how a user encounters a billboard engagement and how conditions for each engagement must be handled by that user to receive final content. According to one embodiment, the user must first meet the overall condition of the system by having triggered the billboard in question 910. Once they have passed by the board, they find the engagement on their listings 930. The user must then view the content within the allowable timeframe 940, which is most often 24 hours. The first presentation of content is the initial content 960 according to the FIG. 9 embodiment. Typically, this content, in combination with the message on the billboard, will make clear the condition that the user must meet. The application will also provide information about the user's location when they have begun to view this content 970. If the user has satisfied the condition 980, the application will call the server for the next response (which may be the final) for rendering within the application 590, according to one embodiment. At this point, the user has met conditions and viewing final content. In one embodiment, the last step in this process is to record the result of this interaction with the user into the MCDS server 595.

FIGS. 10-16 illustrate different potential uses of the MCDS, according to various embodiments. All of these examples are started with two steps: first, the MCDS pushes eligible content listings to the user (125); second, a user engages (e.g., clicks) a particular content listing described. From thereon it is described below, in a different examples and embodiments, what processes could follow.

In the FIG. 10A embodiment, the user is only required to pass by the billboard location, view the listing, click on the listing row for that engagement to receive final content, in 1075. Final content could be a mobile page, image, coupon, or other content. As previously discussed, the final content can be customized. Accordingly, in one embodiment, factors deriving from the user profile or weather conditions at the time of passby could be utilized to customize or assist in determining the content that is delivered, as could various other factors or considerations, as will be discussed in the following examples.

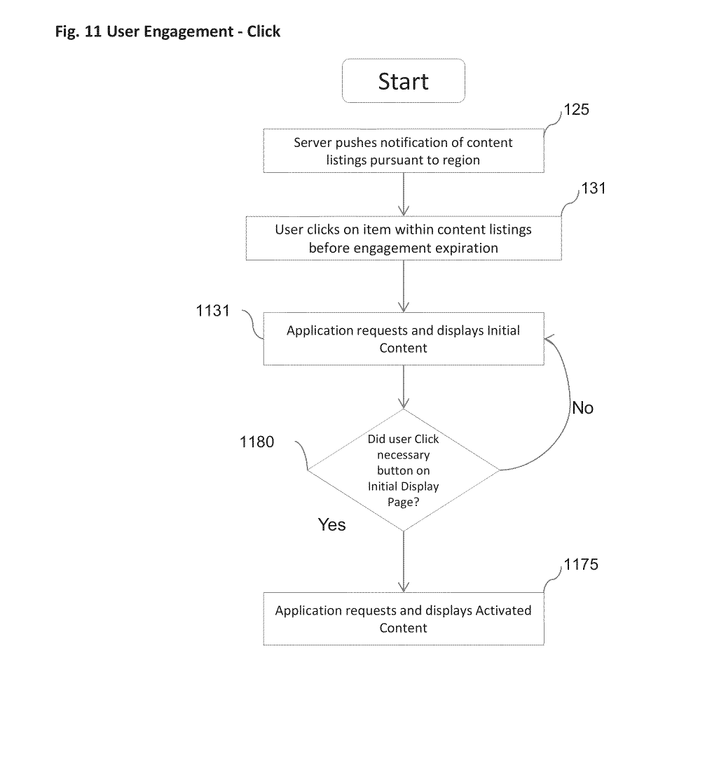

In the FIG. 11A embodiment, the user must pass by the billboard location, view the listing, click on the listing row for that engagement, view the initial content mobile page 1131 and then click on this page 1180 to receive final content 1175. In this embodiment, the advertiser requires that the user view the initial mobile page and click a button.

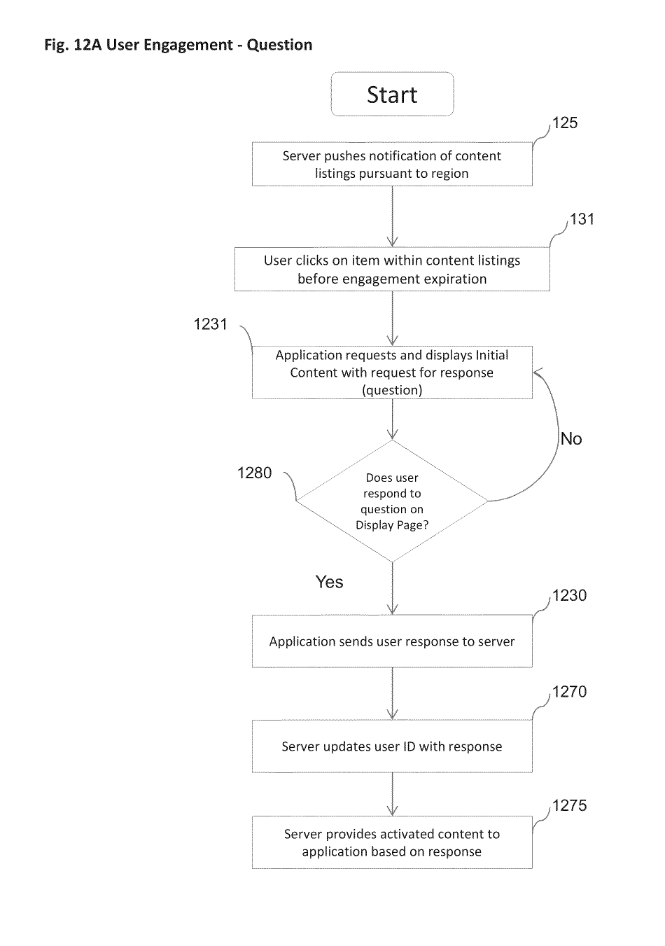

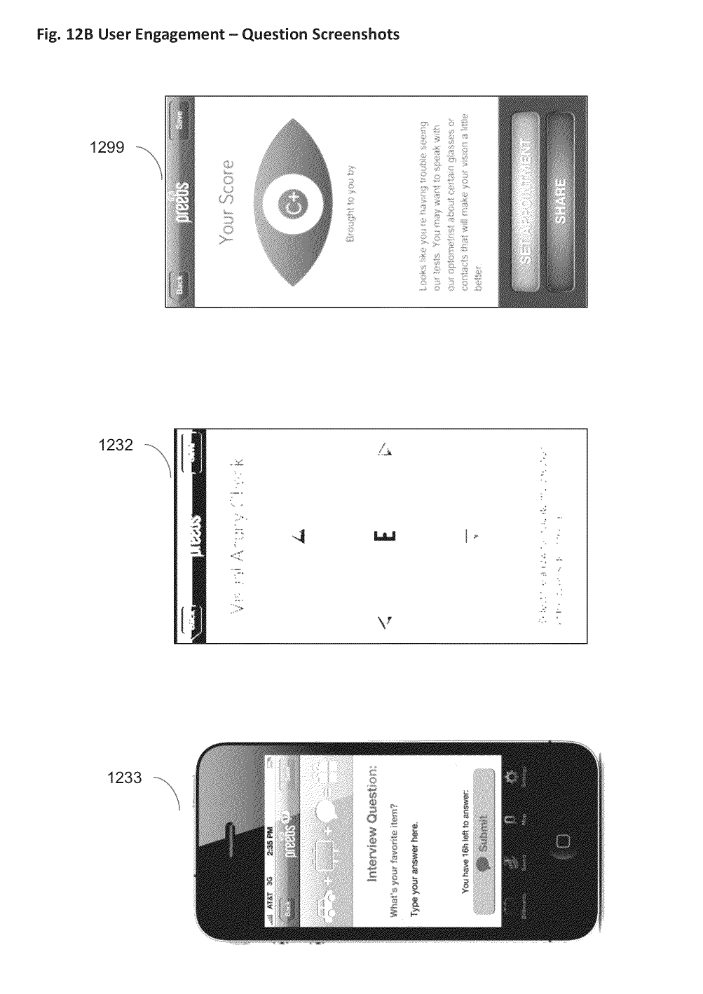

In the FIG. 12A embodiment, the user must pass by the billboard location, view the listing, click on the listing row for that engagement and review the mobile page that is next. In this embodiment, the initial page prompts a response from the user, in 1231. According to one embodiment, this prompt can take many forms, but generally will be an extension of the original message on the billboard. In other words, the content is not delivered until the user can prove they were not only in the vicinity of the billboard, but can provide some information about the billboard to further confirm the user viewed the message itself. In any case, this example could prompt a response in many ways such as: voting for a candidate, taking an eye exam, or requesting a free form response to an opinion question. The user response 1230 will be sent to the MCDS by the device application. The user ID record is updated to reflect the response 1270. Lastly, according to the FIG. 12A embodiment, the server provides the final content 1275 to the device.

FIG. 12B shows screenshots of question based content pages. 1233 and 1232 show examples of actual questions being posed by the system. 1299 shows an example of what final content may look like, in this case a calculated score based on several inputs by a user.

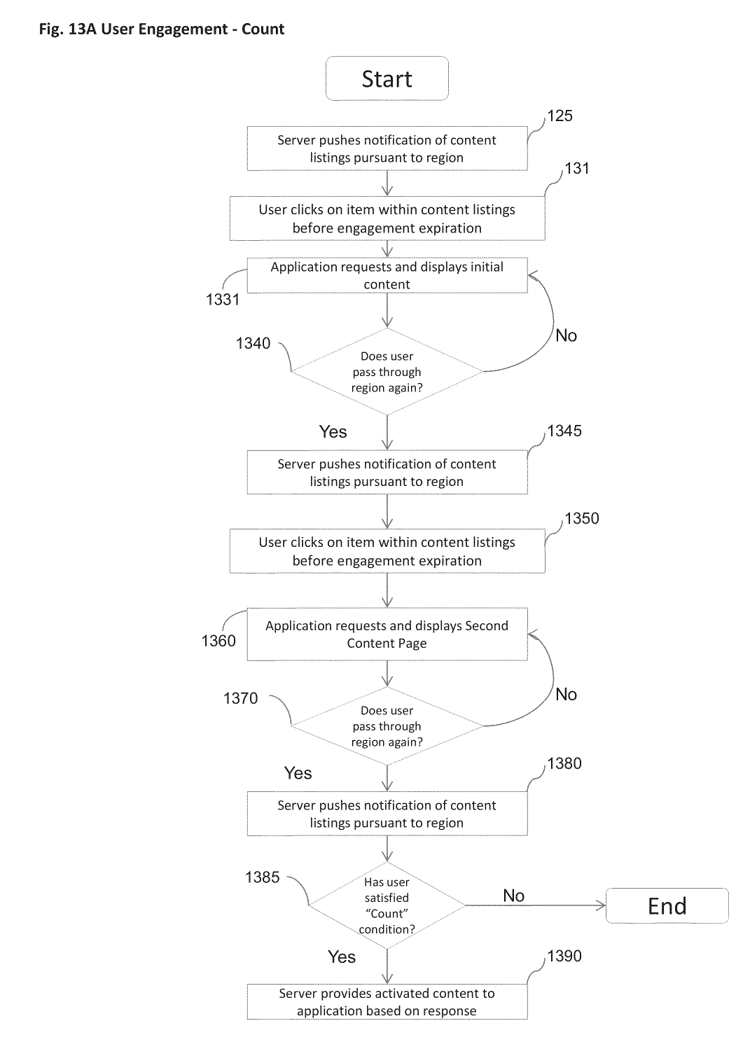

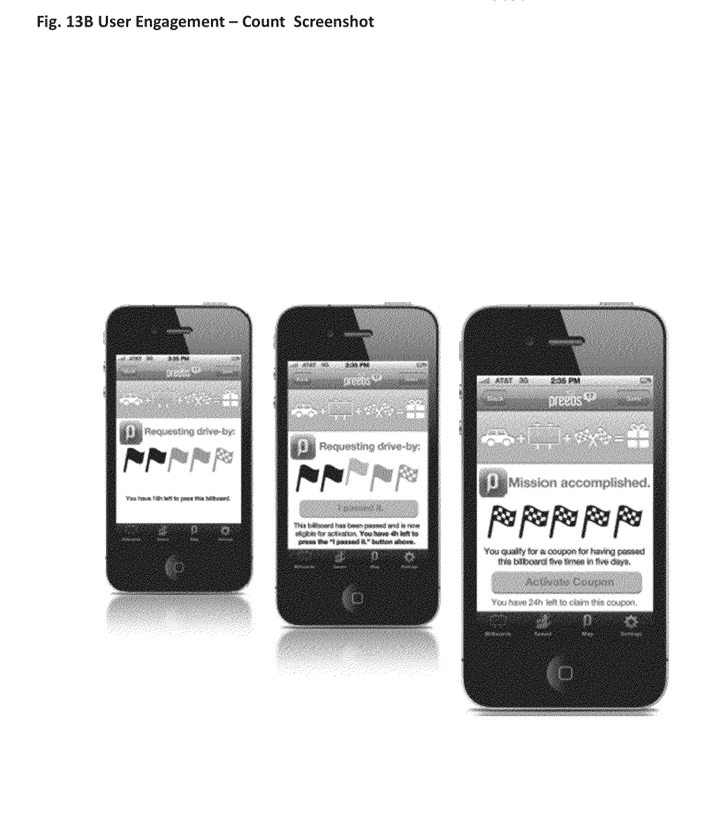

In the FIG. 13A embodiment, the user must pass by the billboard location, view the listing, click on the listing row for that engagement and then repeat these exact steps some time in the future within a stated period of time. As will be understood, this embodiment serves to prove that the user is passing the billboard with regularity, while also making certain the user has incentive to run the application while passing by the billboard. Specific to the FIG. 13A embodiment, the user is first presented with their initial content in 1331. If the user passes by the trigger again 1340 within and consistent with the advertiser determined criteria, the MCDS will push content to the device again 1345. According to one embodiment, this process will continue until the user has fully satisfied the condition 1385, which is ultimately defined by how many triggers are needed in a stated period time. If successful, final content is delivered to the device 1390.

FIG. 13B shows an exemplary screenshot of what count-based content engagement may look like, according to one embodiment.

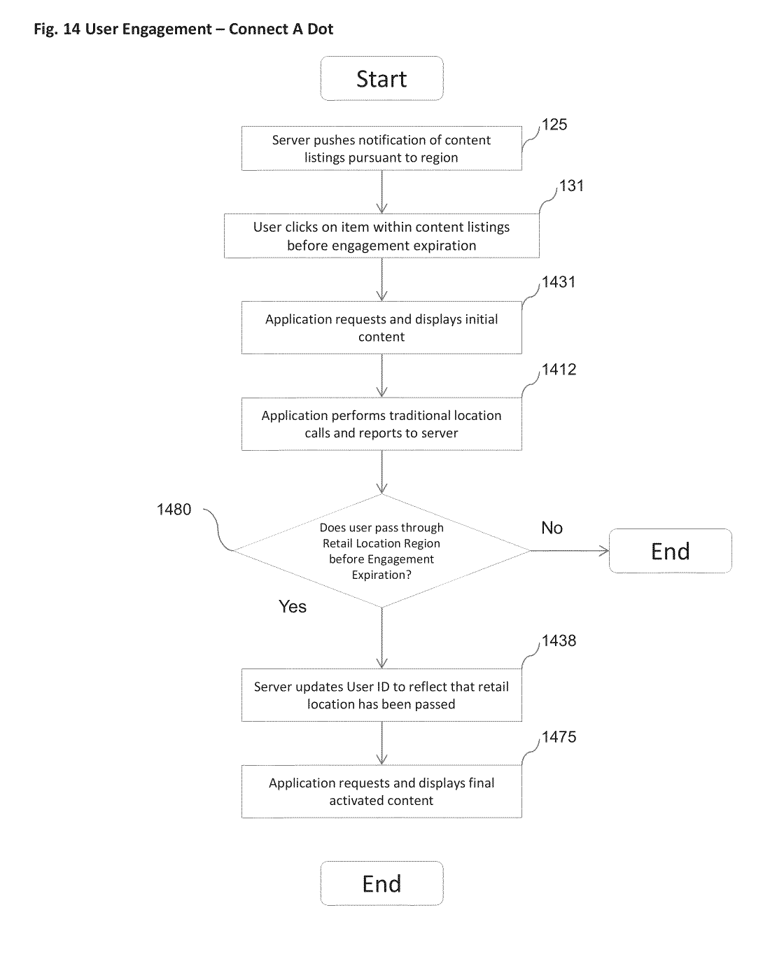

In the FIG. 14 embodiment, the user must pass by the billboard location, view the listing, click on the listing row for that engagement and then reach another location specified by the advertiser. In most cases, this embodiment will involve the use of a retailer advertising billboard message and the secondary location would likely be their retail location. In the FIG. 14 embodiment, this process begins when the MCDS first distributes the initial content 1431. Next, the application will return location information to the MCDS in a typical manner 1412. As with typical triggers, the application will then match locations for the advertiser's retail locations 1412. If the device is found to be in proximity to a retail location, as defined by the advertiser, the server will update the user ID to reflect eligibility for final content 1438. This, in effect, indicates that the user has successfully met the condition of the engagement, as will be understood and appreciated.

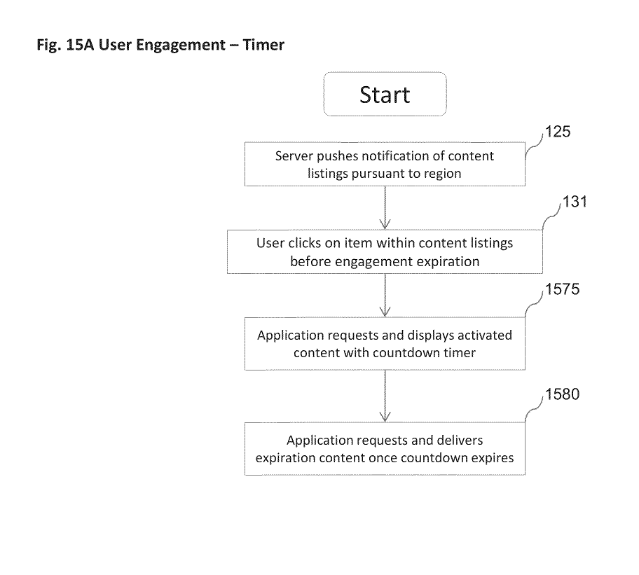

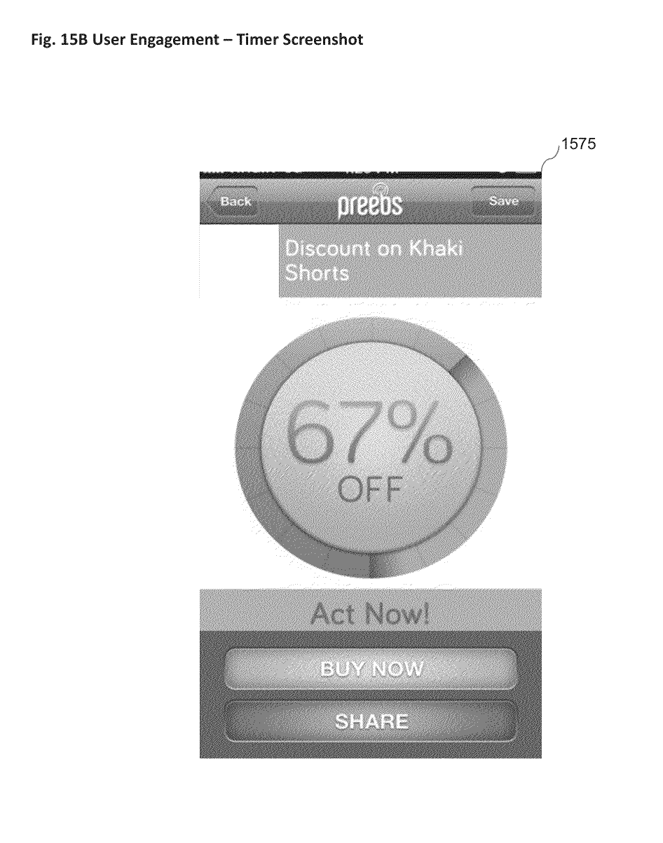

In the FIG. 15A embodiment, the user will click on an engagement as normal, but the engagement itself with expire sooner than normal. Further, the actual initial content 1575 itself represents a countdown timer once the engagement is opened for the first time. This timer will expire 1580 as determined by the advertiser. The timer may offer particular rewards or content if something is performed by the user before the activated content timer expires. FIG. 15B is a screenshot of an unexpired timer content page.

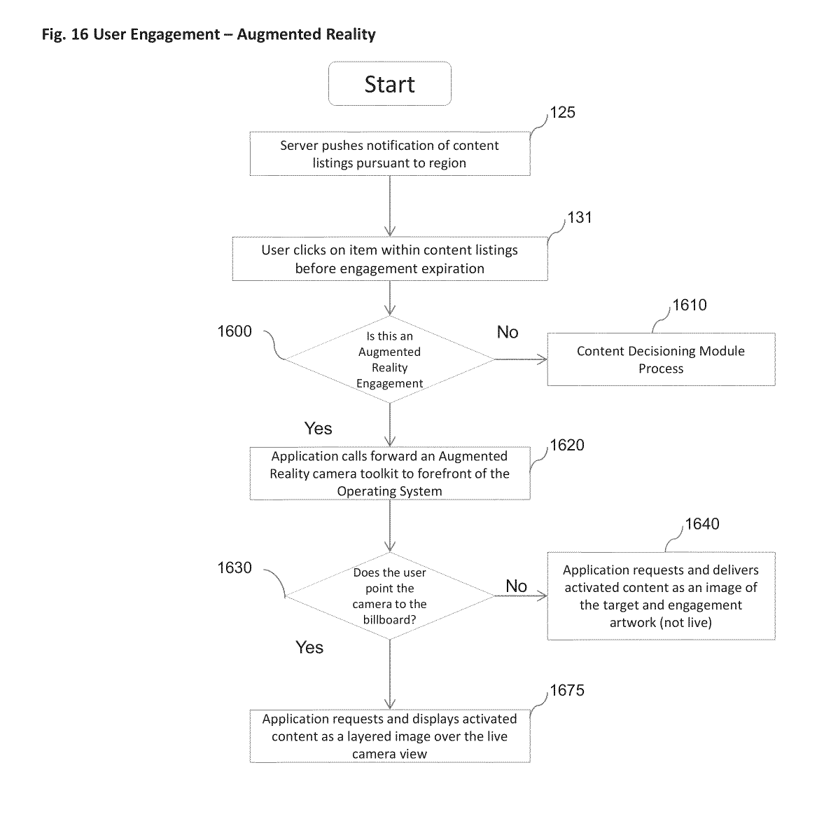

In the FIG. 16A embodiment, a user has the ability to utilize an augmented reality toolkit that resides within the mobile application. This tool recognizes billboard images (as determined by the advertiser) and overlays in the mobile screen certain images and text over the billboard images as seen through the mobile device's camera lens. If a user triggers an AR engagement and clicks on the listing 1600, the application will call forward the installed AR toolkit, as in 1620. If the device is in proximity of the billboard target is the phone's AR tool is pointed at the billboard, the application displays layered content 1675. Layered refers to the method by which advertiser provided images and text are shown over the image within the camera lens rendering on the device, as will be understood by one of ordinary skill in the art. Alternatively, the user may see this content represented as a mobile page only 1640 in the event that user views the content after leaving the proximity of a billboard target.

These examples are housed and managed within the content management platform, according to one embodiment. They are all common in that they require some condition to receive content, are related to messages displayed in the physical realm on billboards and provide custom content based on their responses to these contextual elements that are not stored on any other platform.

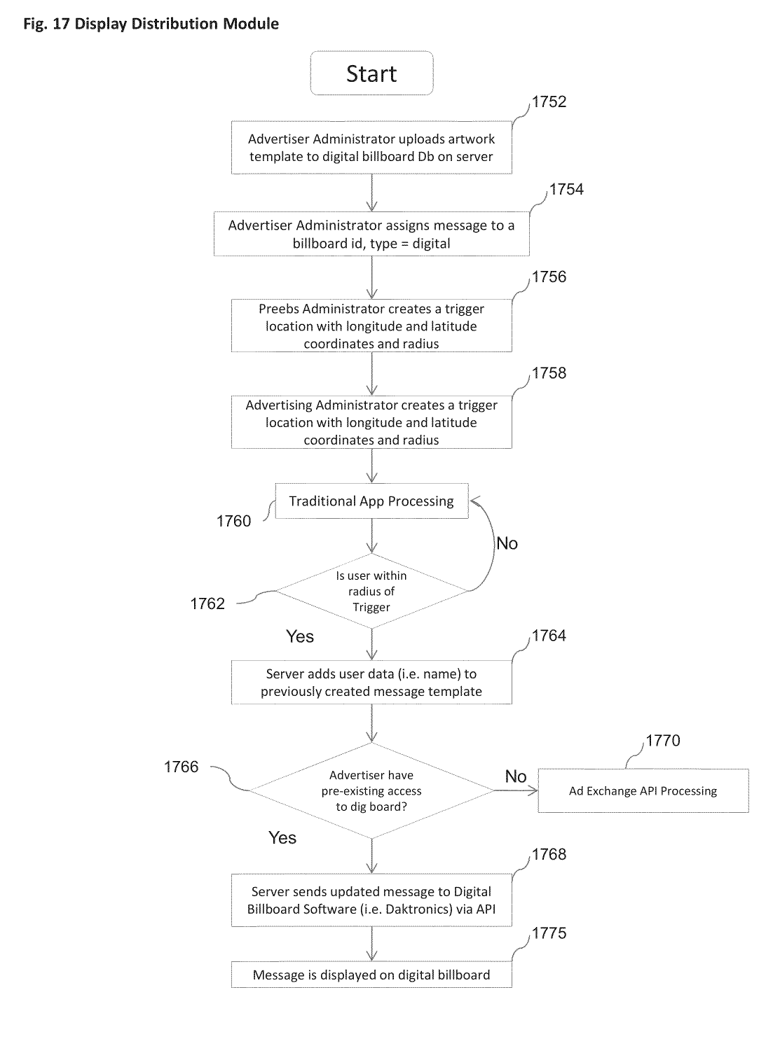

The FIG. 17 embodiment, showcases the MCDS's capability to customize content for users is an example where the content on the device is traditional in the MCDS's context, but the MCDS allows the billboard message to be altered. The display distribution module within the system allows a user to see messages that are personalized for them. According to one embodiment, the advertiser in this figure first creates an overall artwork template for the message that will be displayed on a digital billboard 1752. This template has defined fields where information will be inserted in real time before the message is loaded to the billboard. In one such case, an advertiser could use a specific user's data to insert into a message displayed on a digital billboard that the advertiser is reasonable certain will come within line of sight of the billboard. The advertiser determines timing and what user information to utilize by defining a separate trigger, which is then input by the platform administrator 1756. This trigger is a location that the user will likely pass before being within sight of the billboard. Once the user passes the trigger 1762, the user information is passed to the server, inserted into the advertiser message and then the advertiser schedules the message to be displayed in near real time 1768. Once completed, the actual digital billboard will display the message for the user 1775, according to one embodiment. This process could be set in motion for numerous digital billboard, numerous message templates types and could be made to deliver different templates based on the characteristics of the user.

FIG. 17A shows an illustration of how such a process might occur, according to one embodiment. Here, the actual artwork 1755 is uploaded by the advertiser 1702, a trigger 1724 awaits the user 1710, and once the user passes by the trigger the message 875 is shown on the digital billboard. Once completed, the user has a copy of the message on their device 1780, according to the FIG. 17A embodiment.

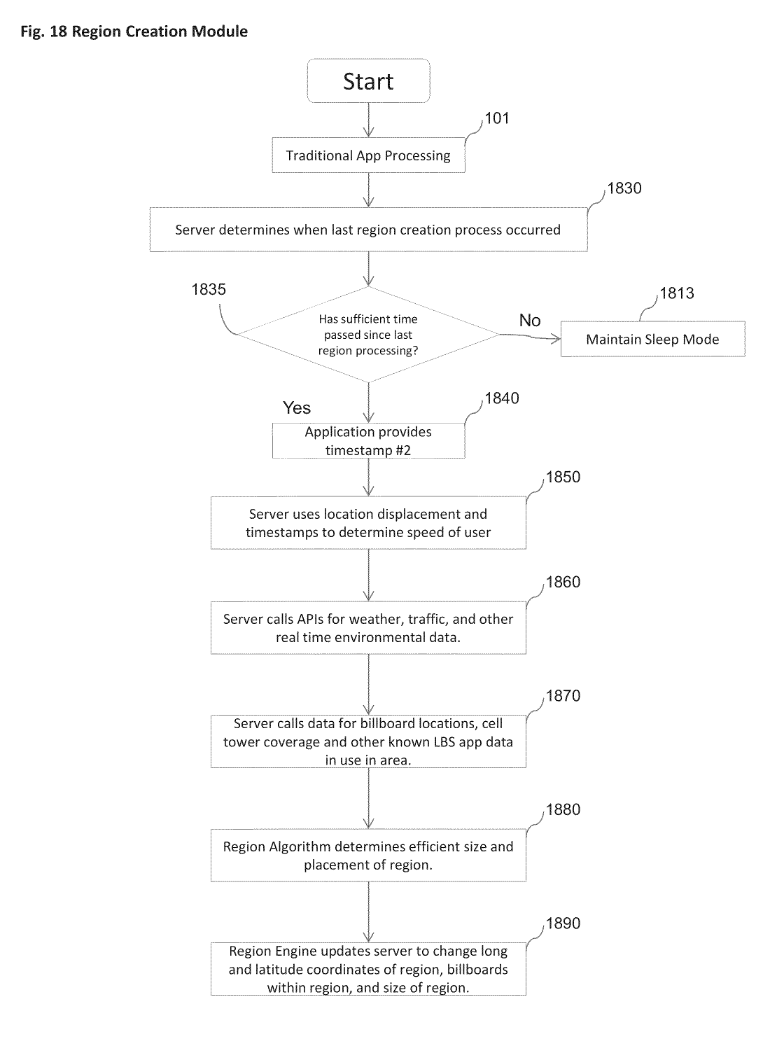

Region Creation Module is a process by which the application provides location to the server on two or more distinct and consecutive instances, as shown in FIG. 18. According to on embodiment, the server takes this information and computes several data points (for example, average speed) to determine the most efficient method of organizing billboards into regions when battery drain on the device may be an issue. The first step is for the server to determine the last time this region was changed 1830. If sufficient time has not passed 1813, the region may remain unchanged. If enough time has passed 1835, the server will record a second location call and time stamp 1840. The first process completed by the region creation module is to determine the speed of the device with this information as in 1850. The module then begins to call APIs 1860 that provide other environmental, real time data that may include: time, traffic flow, weather, estimated location calls utilized by other applications, local Wi-Fi signals, etc. The module will then begin to compute historical data housed within the server about items such as Cell Tower Coverage and billboard locations 1870, according to one embodiment.

With the combination of this information, the region creation module determines the most efficient size and shape of the region 1880 to best accommodate the user devices. In many case the most important factor will be speed, while all other factors remain relatively similar. The final process once a region has been created is for the MCDS to update records in the billboard database, according to one embodiment.

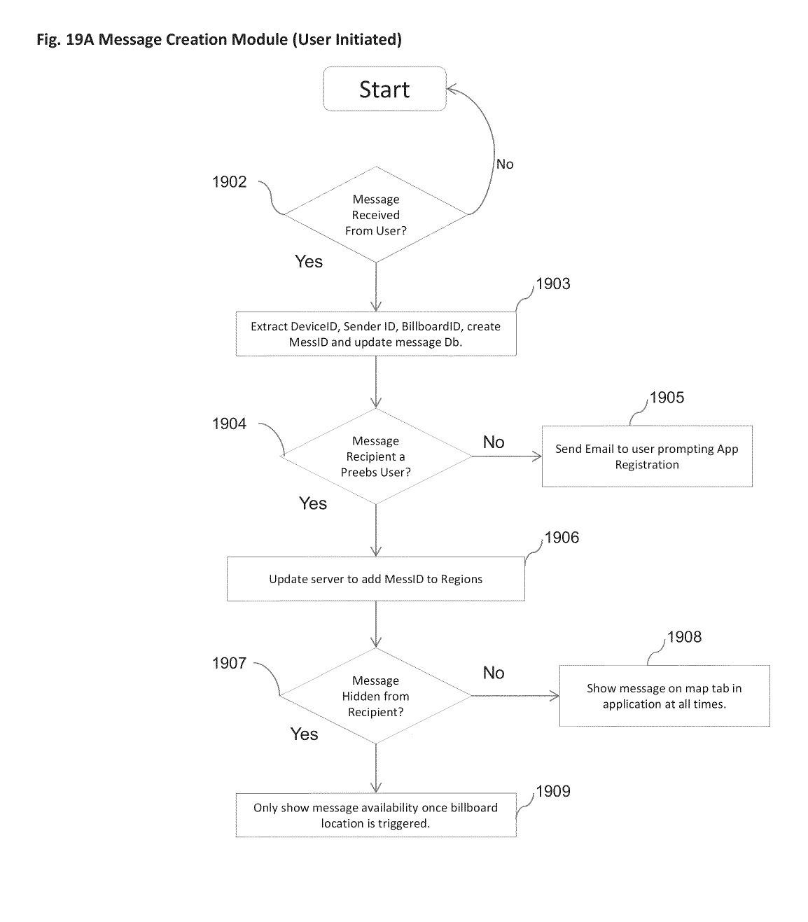

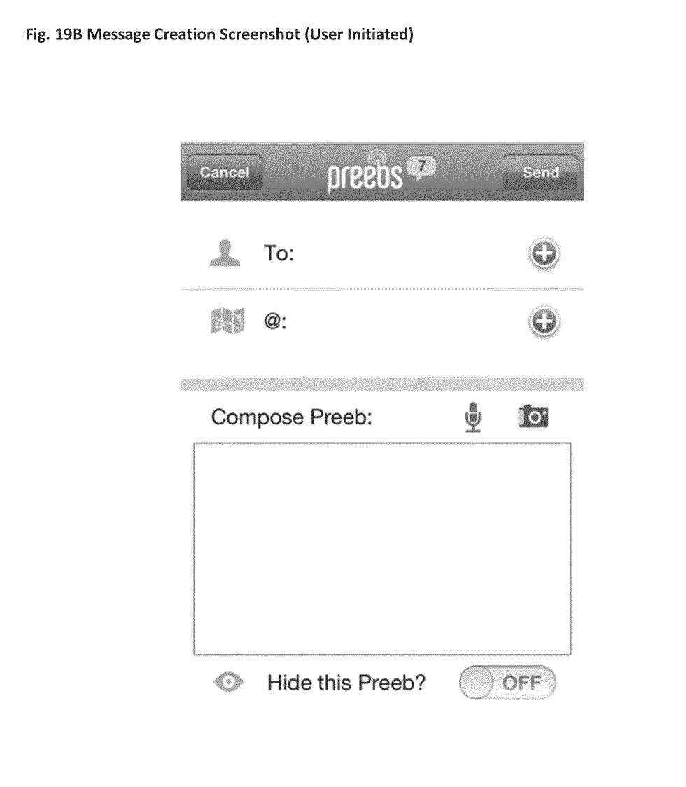

As shown in FIG. 19, users may also create content that is pushed to other users via the MCDS. A sender may utilize any billboard within the network to place their message. The sender may choose any recipient they wish utilizing a network address of existing users or an e-mail address for those recipients that will need to register before becoming eligible to receive the content. In one embodiment, the registered recipient will use the device app as normal, but will see, in addition to advertiser content where applicable, a message from the sender if the recipient passes the trigger chosen by the sender. This message can display any manner of multimedia messaging.

In FIG. 19, the server periodically updates the message database for any newly created messages 1902. If a new message is found, information is gathered to create a new record 1903. If the message was sent to an existing application user, then the user ID record in the platform is updated to reflect a new message is available 1905. If the recipient is not an existing user, an email notification is sent to that user with instructions on how to retrieve the message 1906, according to one embodiment. There exists an option in the system to “hide” the message 1907. This hidden message feature indicates that an existing application user recipient will not have a mapping notice of the message 1909 awaiting them at a particular billboard location. Instead, that user must pass the billboard location before being alerted or become eligible to view the message content 1908. In the case of a non application user, the email notification will act as an alert of a hidden message, but that message will not show on the map once they have registered. This mapping indication is simply a discolored representation of a billboard on the application's map tab that indicate it's slightly different from a traditional billboard engagement, according to one embodiment.

FIG. 19B is a screenshot illustrating, in a mobile interface, how a message input form might be rendered.

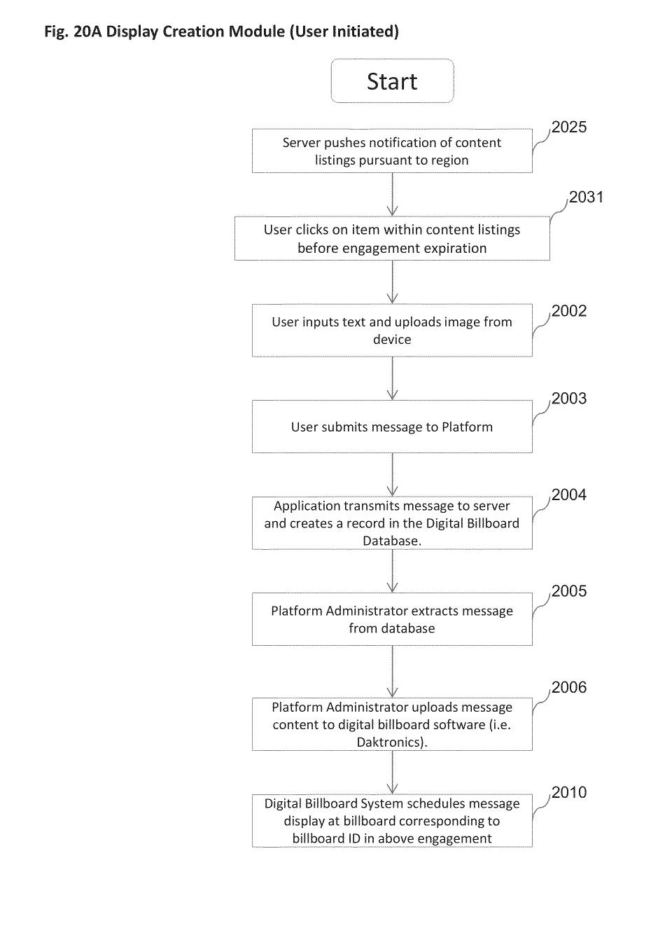

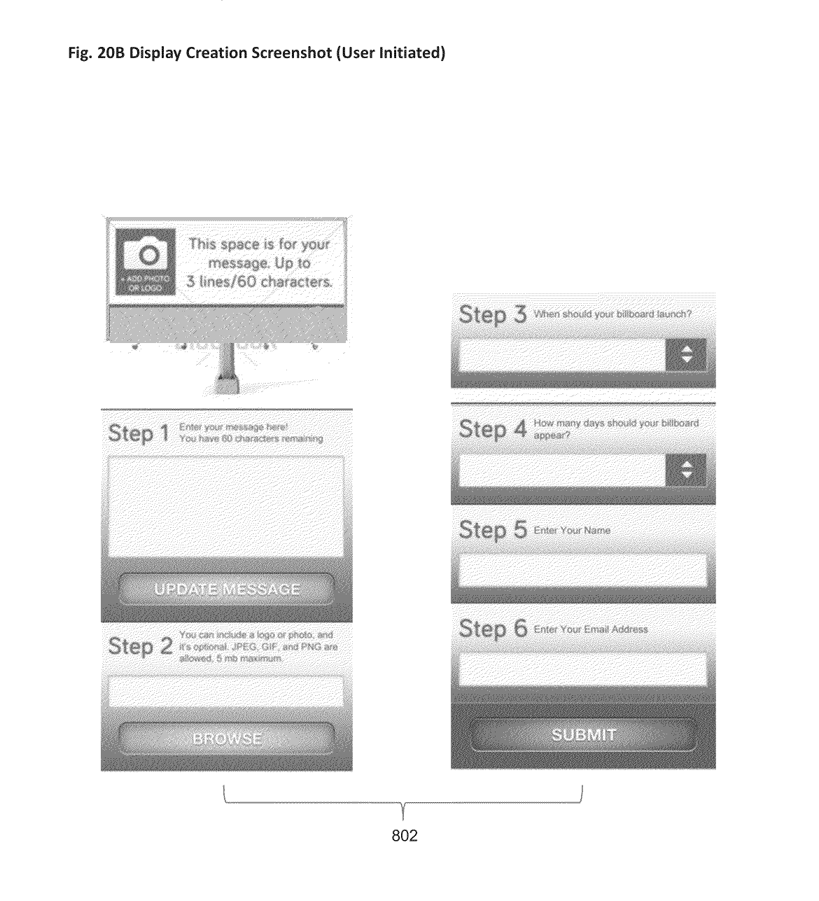

The FIG. 20 embodiment illustrates how a user can create a message in the application for distribution to a digital billboard in the physical realm. This process begins with typical application processing, where the listing of content is provided 2025. The user will click on the listing item that refers to “creating your own” billboard 2031, as shown in the FIG. 20 embodiment. The user will write their message and upload an image from their device 2002. As the user is inputs this information, a visual representation of the billboard message renders at the top of the screen throughout the process. Once the user is finished creating their message, they will submit it to a system administrator 2003. The server is updated to reflect a new message for this particular digital billboard 2004. The platform administrator will then extract the message 2005 and utilize a third-party scheduling software to prepare 2006 for the display of this message on the subject digital billboard 2010, as will be understood by one of ordinary skill in the art.

In one embodiment, the creation of display messages by users may be accomplished from a desktop computer as well, requiring no location conditions. FIG. 20B shows a screenshot of how such a message input form could be rendered for a mobile interface.

The FIG. 21 embodiment illustrates a sample database structure that could support the MCDS. These components shown would accommodate some of the functions of the system, but do not represent all components needed to accommodate the conditions and other ramifications of the present disclosure.

FIG. 22 is a sequence diagram that illustrates, by time, a typical MCDS process, according to one embodiment.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. In a mobile content distribution system (MCDS), wherein the MCDS includes an MCDS central server for performing various operations of the MCDS, and wherein the MCDS is in operative communication with a plurality of users operating a plurality of mobile devices for receiving content, a method comprising the steps of:
receiving location information at the MCDS central server specifying a geographical location of a mobile device associated with a particular user of the MCDS;
determining if the geographical location of the mobile device of the particular user is inside of a predetermined content distribution region;
upon determination that the geographical location of the mobile device of the particular user is inside of a predetermined content distribution region, presenting a list of predetermined region-specific content items to the particular user via the mobile device;
receiving selection confirmation at the MCDS central server indicating selection by the particular user of a particular region-specific content item via the mobile device;
in response to receipt of the selection confirmation, presenting user content corresponding to the particular region-specific content item to the particular user via the mobile device;
receiving user engagement information at the MCDS central server indicating user engagement by the particular user with the user content;
determining whether the user engagement information satisfies a preexisting user engagement criteria; and
upon determination that the user engagement information satisfies the preexisting engagement criteria, distributing supplemental content to the particular user corresponding to the particular region-specific content item via the mobile device.

2. The method of claim 1, wherein the supplemental content is selected from the group comprising: an image, a coupon, a mobile webpage.

3. The method of claim 1, wherein the user engagement criteria must be completed in a predetermined period of time.

4. The method of claim 3, wherein the predetermined period of time is 24 hours.

5. The method of claim 1, wherein the user engagement criteria comprises a set of rules specifying a predetermined minimum of content distribution region re-entries by the mobile device of the particular user.

6. The method of claim 5, wherein user engagement criteria further comprises a set of rules specifying a requirement that the user view a website associated with the user content.

7. The method of claim 6, wherein the website associated with the user content specifies additional user engagement criteria.

8. The method of claim 7, wherein the additional user engagement criteria further comprises a set of rules specifying a requirement that the user input additional information associated with the predetermined content distribution region into the website associated with the user content.

9. The method of claim 7, wherein the additional user engagement criteria further comprises a set of rules specifying a requirement that the user travel to a secondary location specified by the website associated with the user content.

10. The method of claim 7, wherein the additional user engagement criteria must be completed in a predetermined period of time.

11. The method of claim 1, wherein the predetermined content distribution region is configured based on the location of a stationary media location.

12. The method of claim 11, wherein the stationary media location is selected from the group comprising: billboard, bus stop shelter, store front advertisement.

13. The method of claim 1, wherein the predetermined content distribution region is configured based on the location of a moving media channel displaying exterior-facing signage.

14. The method of claim 13, wherein the moving media channel displaying exterior-facing signage is selected from the group comprising: shipping container, tractor trailer, bus, shuttle, delivery truck, mobile billboard.

15. The method of claim 1, wherein the predetermined content distribution region is configured based on the location of a digital billboard.
